(19) United States
(12) Patent Application Publication
(10) Pub. No.: US 2026/0082227 A1
(43) Pub. Date: Mar. 19, 2026

(54) SYSTEMS AND METHODS FOR AIR INTERFACE ENTITY-TO-AIR INTERFACE ENTITY INTERFACES IN CELL-FREE NETWORKS

(71) Applicant: APPLE INC., Cupertino, CA (US)

(72) Inventors: Ahmed Gamal Helmy Mohamed, Cupertino, CA (US); Naveen Kumar R. Palle Venkata, San Diego, CA (US); Danila Zaev, Munich (DE); Ayman F. Naguib, Cupertino, CA (US)

(21) Appl. No.: 19/327,571

(22) Filed: Sep. 12, 2025

Related U.S. Application Data
(60) Provisional application No. 63/694,353, filed on Sep. 13, 2024.

(51) Int. Cl. H04W 12/08; H04W 12/0471

(52) U.S. Cl. CPC H04W 12/08; H04W 12/0471

(57) ABSTRACT

Systems and methods for air interface entity-to-air interface entity interfaces in cell-free networks are discussed herein. An initiator air interface entity of a cell-free network using dynamic associations of air interface entities and cloud entities receives, from a cloud entity, an instruction to transition a state of an eXn interface between the initiator air interface entity and a responder air interface entity from a starting state to an active state; transitions, in response to the instruction, the eXn interface to the active state; and performs cross-air-interface-entity communication with the responder air interface entity over the eXn interface after the eXn interface is transitioned to the active state. Mechanisms of transitioning eXn interfaces to an inactive state or a standby state are also discussed. Corresponding behaviors for responder air interface entities are discussed. Corresponding behaviors for cloud entities are also discussed.

### CROSS-REFERENCE TO RELATED APPLICATION

This application claims the benefit of U.S. Provisional Patent Application No. 63/694,353, filed Sep. 13, 2024, entitled “DISTRIBUTED UNIT-DISTRIBUTED UNIT INTERFACES IN CELL-FREE NETWORKS,” which is hereby incorporated by reference herein in its entirety.

### TECHNICAL FIELD

This application relates generally to wireless communication systems, including the implementation of cell-free networks capable of implementing interfaces between pairs of air interface entities.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for an example of clustering in a cell-free network architecture, according to embodiments discussed herein.

FIG. 2 illustrates a network hierarchy as may be used in some 5G wireless communication systems.

FIG. 3A exemplifies a dynamic DU (distributed unit)-DU interface with 6G NTN (non-terrestrial network) mobility.

FIG. 3B exemplifies a dynamic DU-DU interface with 6G NTN disaggregation.

FIG. 3C exemplifies a dynamic DU-DU interface with a mmWave transport network.

FIG. 4 illustrates an example of a potential 6G network architecture.

FIG. 5A illustrates an example of eXn interface use, according to embodiments discussed herein.

FIG. 5B illustrates an example of eXn interface use, according to embodiments discussed herein.

FIG. 6 illustrates an example of eXn interface use, according to embodiments discussed herein.

FIG. 7 illustrates a state machine for transitioning an eXn interface as between an ACTIVE state, an INACTIVE state and a STANDBY state, according to embodiments discussed herein.

FIG. 8 illustrates an example network architecture showing various of roles and responsibilities of various network entities corresponding to an eXn interface, according to embodiments discussed herein.

FIG. 9 illustrates an example eXn ISR procedure, according to embodiments discussed herein.

FIG. 10 illustrates an example of a discovery and configuration restoration protocol operating according to an initialization mode of an ISR, according to embodiments discussed herein.

FIG. 11 illustrates an example of a discovery and configuration restoration protocol operating according to a reactivation mode of an ISR, according to embodiments discussed herein.

FIG. 12 illustrates an example of a negotiation and rapid parameter setting protocol according to an initialization mode of an ISR, according to embodiments discussed herein.

FIG. 13 illustrates an example of a negotiation and rapid parameter setting protocol according to a reactivation mode of an ISR, according to embodiments discussed herein.

FIG. 14 illustrates an example of a security and authentication protocol according to an initialization mode of an ISR, according to embodiments discussed herein.

FIG. 15 illustrates an example of a security and authentication protocol according to a reactivation mode of an ISR, according to embodiments discussed herein.

FIG. 16 illustrates an example activation confirmation protocol according to an initialization mode of an ISR, according to embodiments discussed herein.

FIG. 17 illustrates an example activation confirmation protocol according to a reactivation mode, according to embodiments discussed herein.

FIG. 18 illustrates an example eXn IST procedure, according to embodiments discussed herein.

FIG. 19 illustrates an example of a session safeguard and transition protocol according to all modes of an IST procedure, according to embodiments discussed herein.

FIG. 20 illustrates an example of a session safeguard and transition protocol according to termination mode and/or a standby deactivation mode of an IST procedure, according to embodiments discussed herein.

FIG. 21 illustrates an example of a session safeguard and transition protocol according to a hibernation mode of an IST procedure, according to embodiments discussed herein.

FIG. 22 illustrates an example data management and preservation protocol according to all modes of an IST procedure, according to embodiments discussed herein.

FIG. 23 illustrates another example data management and preservation protocol according to all modes of an IST procedure, according to embodiments discussed herein.

FIG. 24 illustrates an example of a security and clearance protocol according to all modes of an IST procedure, according to embodiments discussed herein.

FIG. 25 illustrates an example of a security clearance and protocol 2502 according to termination mode and/or a standby deactivation mode of an IST, according to embodiments discussed herein.

FIG. 26 illustrates an example of a security and clearance protocol according to a hibernation mode of an IST, according to embodiments discussed herein.

FIG. 27 illustrates an example of an operational reset and shutdown protocol according to all modes of an IST procedure, according to embodiments discussed herein.

FIG. 28 illustrates a method of an initiator air interface entity of a cell-free network using dynamic associations of air interface entities and cloud entities, according to embodiments discussed herein.

FIG. 29 illustrates a method of an initiator air interface entity of a cell-free network using dynamic associations of air interface entities and cloud entities, according to embodiments discussed herein.

FIG. 30 illustrates a method of an initiator air interface entity of a cell-free network using dynamic associations of air interface entities and cloud entities, according to embodiments discussed herein.

FIG. 31 illustrates an example architecture of a wireless communication system, according to embodiments disclosed herein.

FIG. 32 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Clustering in Cell-Free Networks

In some wireless communication systems, a cell-free network architecture provides an adaptive/dynamic and UE-centric distribution of functionalities that may be associated with a “serving cell” as understood in the context of prior cell-based network architectures (e.g., such as an NR network architecture or an LTE network architecture). With respect to the present disclosure, it may be understood generally that a “cluster” or “serving cluster” of a UE is a set of physically and/or logically connected base stations over which functionalities related to the serving the UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

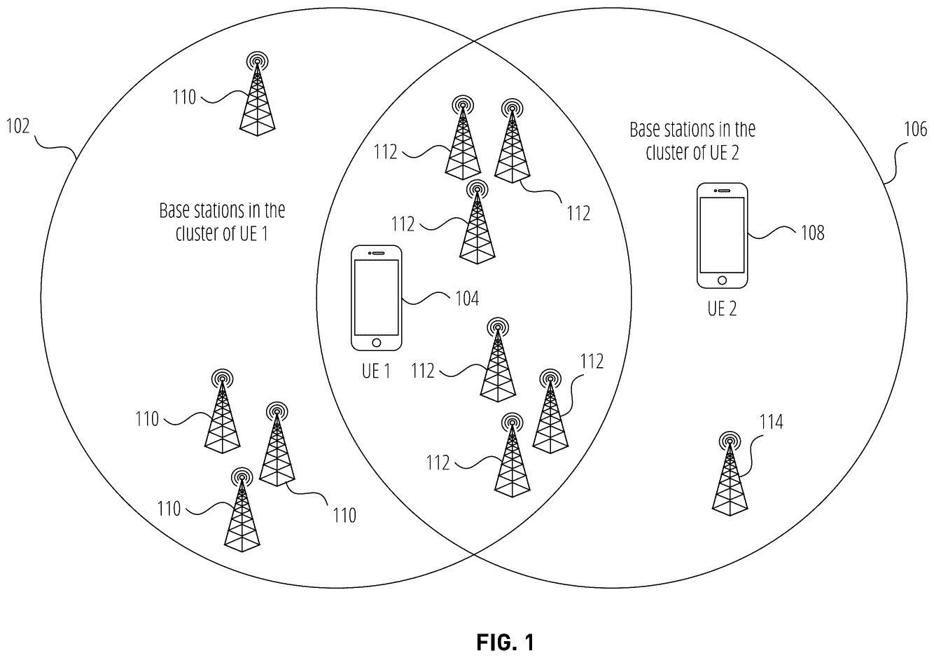

FIG. 1 illustrates a diagram for an example of clustering in a cell-free network architecture. A first cluster 102 of base stations serves a first UE 104 and a second cluster 106 of base stations serves the second UE 108. As illustrated, the first cluster 102 includes the first base stations 110 and the second base stations 112, while the second cluster 106 includes the second base stations 112 and the third base station 114.

Base stations in a same cluster are not necessarily needed to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core network, a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QoS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE's initial access). These may include, for example, “greedy”, downlink (DL)-based, uplink (UL)-based, and/or real-time methodologies (and any corresponding message exchanges).

### Discussion of Logical Interfaces in 5G Systems

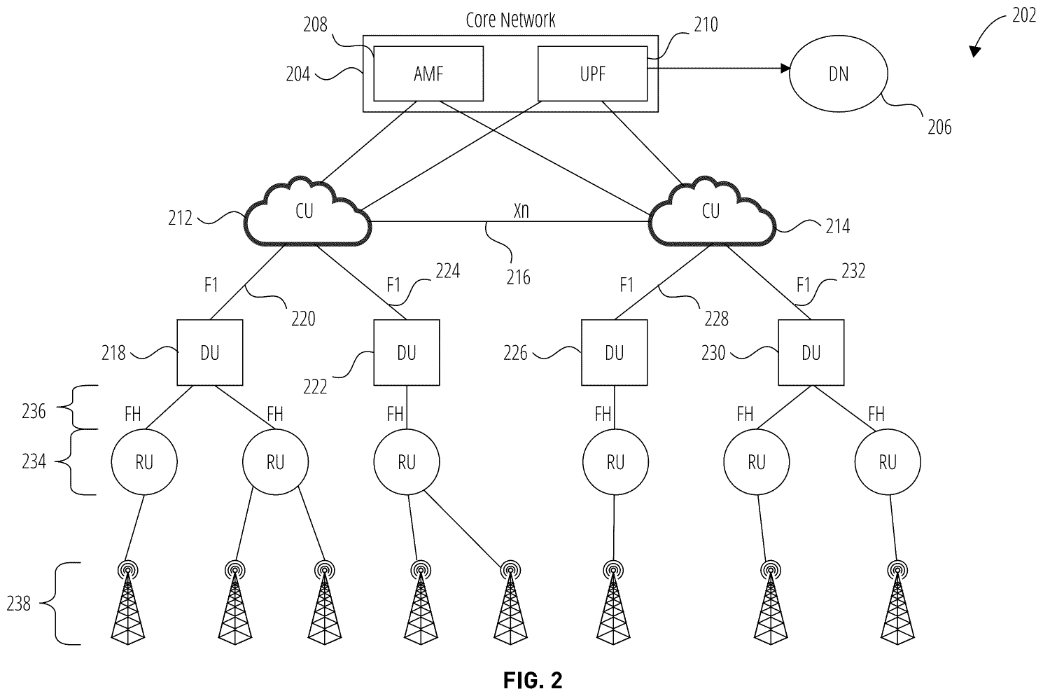

FIG. 2 illustrates a network hierarchy 202 as may be used in some 5G wireless communication systems. As illustrated, a core network 204 is connected to a data network (DN) 206. The core network 204 may include, among other things, an access and mobility management function (AMF) 208 and a user plane function (UFP) 210.

Each of a first centralized unit (CU) 212 and a second centralized unit 214 communicates with each of the AMF 208 and the user plane function (UPF) 210 in the core network 204. The first centralized unit 212 and the second centralized unit 214 may communicate directly with each other using the Xn interface 216.

A first DU 218 communicates with the first centralized unit 212′ on a first F1 interface 220 and a second DU 222 communicates with the second F1 interface 224 on a second F1 interface 224. Further, a third DU 226 communicates with the second centralized unit 214 on a third F1 interface 228 and a fourth DU 230 communicates with the second centralized unit 214 on a fourth F1 interface 232

The network hierarchy 202 also illustrates that various radio units (RUs) 234 connect back to ones of the DUs just described on corresponding ones of the fronthaul (FH) interfaces 236. The RUs 234 each operate one or more of the radios 238 for their respective DU, as illustrated.

In wireless communication systems implementing 5G, an Xn interface (e.g., the Xn interface 216) may be defined as a CU-to-CU logical interface. The Xn interface may be used for communication between one or more gNBs (CU-to-CU connections) in a 5G network. It primarily supports functions related to user mobility (e.g., handover procedures). The Xn interface includes a control plane aspect (an Xn-C interface) which can handle signaling related to session management, mobility control, UE context management, and a user plane aspect (an Xn-U interface), which facilitates the transfer of user data during inter-gNB handovers.

Handover management may be defined as the managing of one or more inter-gNB handovers, which ensures seamless UE mobility between different gNBs. Load balancing and inter-cell interference coordination may allow for load sharing and interference management between gNBs. UE context management may facilitate the transfer of UE context information between gNBs. Paging coordination may allow gNBs to coordinate paging messages when the UE's exact location is unknown.

For 5G networks, the Xn interface is primarily designed for communication between centralized gNBs, and is not tuned for the distributed environment of cell-free systems where many small nodes (DUs) work together. Further, the Xn interface in 5G lacks direct support for low-latency, high-frequency interactions that may be needed between DUs for distributed MAC (medium access control) and RLC (radio link control) processing.

In wireless communication systems implementing 5G, an F1 interface (such as the first F1 interface 220, the second F1 interface 224, the third F1 interface 228, and/or the fourth F1 interface 232) may be defined as a CU-to-DU logical interface. The F1 interface connects a CU and DU for control and user plane communications.

In wireless communication systems implementing 5G, the F1 interface may include a control plane aspect (an F1-C interface). One functionality of the F1-C interface includes a CU-DU setup which manages setup, configuration, and maintenance of the CU-DU connection. Another functionality of the F1-C interface includes UE context management, which facilitates the transfer and management of UE context information between the CU and the DU. Another functionality of the F1-C interface includes RRC message forwarding, which transports RRC messages to and from the DU. Another functionality of the F1-C interface includes paging coordination, which may be defined as coordinating paging messages from the CU to the DU for UEs in an idle or inactive state. Another functionality of the F1-C interface includes error handling, which manages error detection and correction in control-plane communications.

In wireless communication systems implementing 5G, the F1 interface may include a user plane aspect (an F1-U interface). One functionality of the F1-U interface includes data forwarding, which transports user data between the CU and DU. Another functionality of the F1-U interface includes quality of service (QoS) handling, which supports quality of service differentiation for various data flows.

F1 interfaces are designed for a static CU-DU relationship. In cell-free networks, the dynamic and potentially shifting relationships between DUs and CUs may strain the traditional F1 interface capabilities as explained here. The F1 interface might not efficiently handle the rapid switching or rerouting of control and user plane data that is desirable in a distributed RAN environment. Further, the F1 interface does not naturally support a many-to-many relationship, which is helpful for enabling a single DU to be managed by multiple CUs.

### Scenarios for Dynamic DU-DU Interfaces

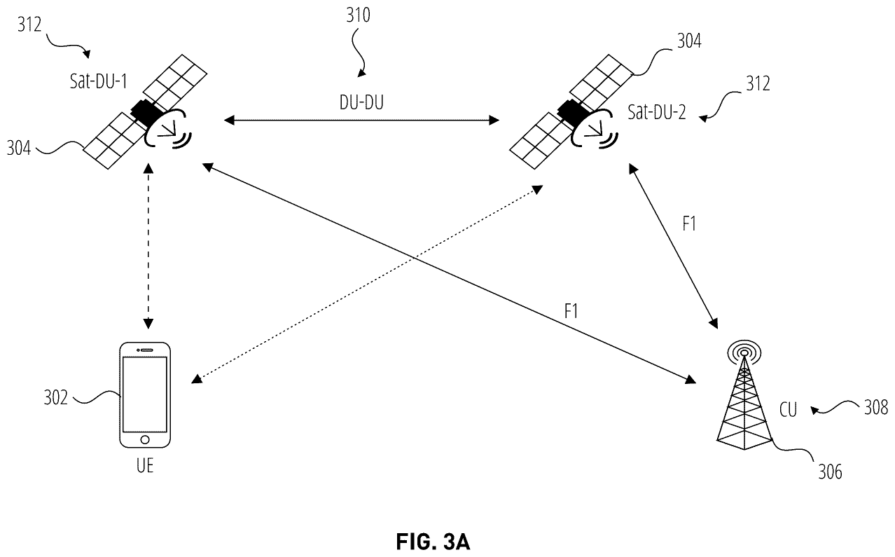

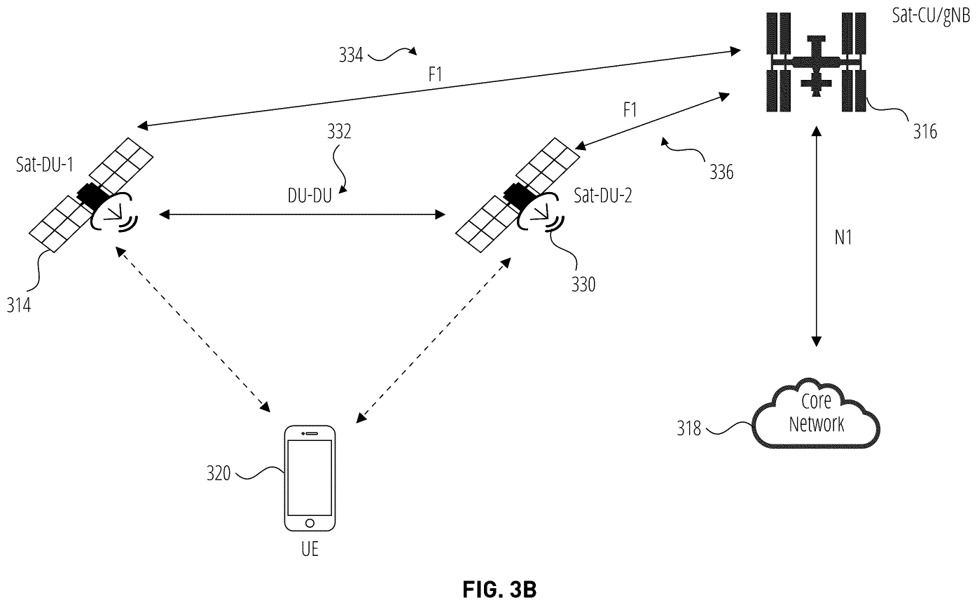

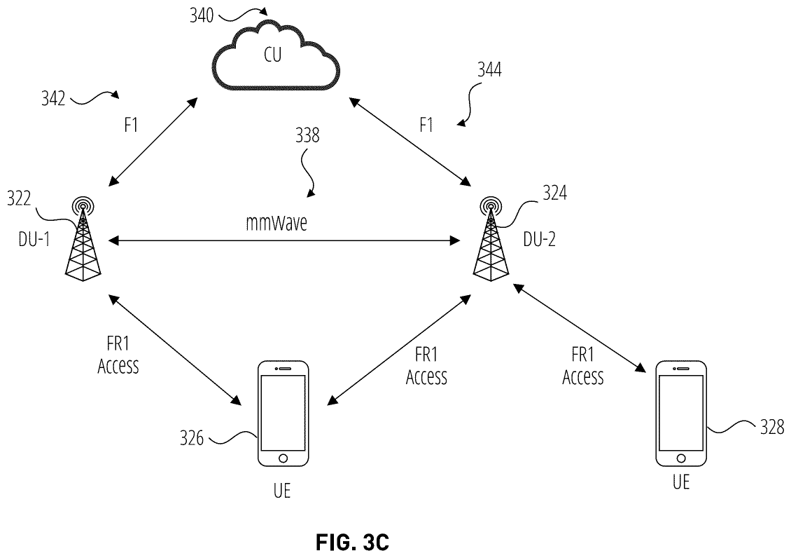

FIG. 3A illustrates an example use of a dynamic DU-DU interface with 6G non-terrestrial network (NTN) mobility. In some wireless communication systems, DU functionality may be implemented by satellites. Some satellites of interest may be connected to the same ground station that implements a CU. A DU-DU interface may be used for mobility procedures between satellites (e.g., handover of cell-free mobility), which may be useful in cases where F1 latency is significant due to propagation times between satellites. Further, if the satellites are low earth orbit (LEO) satellites, then a free-space physical link between them may ultimately disappear as they each travel along their different trajectories.

FIG. 3A illustrates satellites 304 connected to a UE 302 and a ground station 306. The ground station 306 includes a CU 308. The satellites 304 include DU 312 functionality. A DU-DU interface 310 exists between the satellites 304.

FIG. 3B illustrates an example use of a dynamic DU-DU interface with 6G NTN disaggregation. In some wireless communication systems, some satellites may implement DU functionality, and some satellites may implement CU functionality. The CU satellites may be connected to a ground station that serves as a gateway to a core network. A DU-DU interface may be used for coordination between the DU satellites. The latency of either/both of a DU-DU direct link between satellite DUs and a DU-CU direct link between a satellite DU and a satellite CU might vary with time as these satellites travel along their potentially independent trajectories.

FIG. 3B illustrates a dynamic DU-DU interface 332 in a case using 6G NTN disaggregation. A first satellite 314 acting as a DU and a second satellite 330 acting as a second DU connect to a third satellite 316 that acts as a CU. The third satellite 316 is connected to a ground station that serves as a gateway to a core network 318.

The first satellite 314 and second satellite 330 coordinate with each other over a DU-DU interface 332. The first satellite 314 coordinates with the third satellite 316 over a first F1 interface 334. The second satellite 330 coordinates with the third satellite 316 over a second F1 interface 336. A UE 320 may connect via either/both of the first satellite 314 and/or the third satellite 316.

FIG. 3C illustrates an example use of a dynamic DU-DU interface with a mmWave Transport Network. In some wireless communication systems, a direct DU-DU connection may be implemented wirelessly by high-frequency communication.

FIG. 3C illustrates a first base station 322 connected to a first UE 326 via FR1 (frequency range 1) access and to a second base station 324 via a DU-DU interface 338 that takes the form of a mmWave connection. The second base station 324 is connected to the first UE 326 and a second UE 328 via FR1 access. The first base station 322 and the second base station 324 are connected to a CU 340 via, respectively, the first F1 interface 342 and the second F1 interface 344.

In each of the dynamic DU-DU interface scenarios exemplified in FIG. 3A, FIG. 3B, and FIG. 3C, the DU-DU communication may use some resources (e.g., power and/or spectrum). Further, the DU-DU interfaces might not be needed all the time, for example depending on the mobility of a UE, traffic QoS, or satellite mobility.

Going forward within this disclosure, any network node that operates as an “air interface entity” may be referred to as a “DU.” Accordingly, the term “DU” as used going forward includes, but is not necessarily restricted to, the case of a 5G DU as otherwise discussed here/as may be understood with reference to, for example, a 3GPP specification.

Similarly, going forward within this disclosure, any network node that operates as a “cloud entity” may be referred to as a “CU.” Accordingly, the term “CU” as used going forward includes, but is not necessarily restricted to, the case of a 5G CU as otherwise discussed herein/as may be understood with reference to, for example, a 3GPP specification

These uses of the terms “DU” and “CU” are used going forward for the sake of simplicity.

### Embodiments of 6G Network Architectures

One embodiment of a 6G network architecture consists of two interconnected networks; one or more cloud entity networks (CU networks) and one or more air interface entities networks (DU networks). Note that each of these CU networks/DU networks/individual elements thereof may be supplied by different/various vendors.

In some embodiments of a CU network, one or more CUs may be implemented in the cloud and managed by single or multiple CU vendors. In some embodiments, CUs may be responsible for both control plane and user plane functionalities. In some embodiments, CUs may manage aspects of the network, for example: configuration of DUs, radio bearer management, and/or ensuring QoS. In some embodiments, the CUS may interconnect via Xn interfaces, which may support low-latency and high-reliability communication, and may facilitate efficient inter-CU handovers and/or mobility management. This standardized interface can maintain interoperability across different vendor equipment. In some embodiments, when CUs are implemented in the cloud, the Xn interface may be improved compared to current 5G networks where CUs are mostly developed by traditional RAN vendors.

In some embodiments of a DU network, one or more DU units may be deployed closer to a UE to more efficiently manage the air interface. In some embodiments, DUs can be managed by either the same or different vendors that provide the cloud CU network. In this case, the DU vendor may provide DU equipment and may also offer a transport network that is fully transparent to the CU. This may be helpful within cell-free architectures, where a CU is provided by cloud vendors, while DUs are supplied by different vendors and are implemented physically closer to the devices.

These DUs handle most of the Layer 2 functionalities and form a cohesive network controlled by CUs. They can interconnect with each other through proprietary interfaces, which are typically vendor-specific and transparent to the CU. This setup is efficient for managing air interface tasks and reducing latency due to proximity to UEs, but it may limit the CU's ability to monitor and optimize DU-DU communications in the case that proprietary DU-DU interfaces are used.

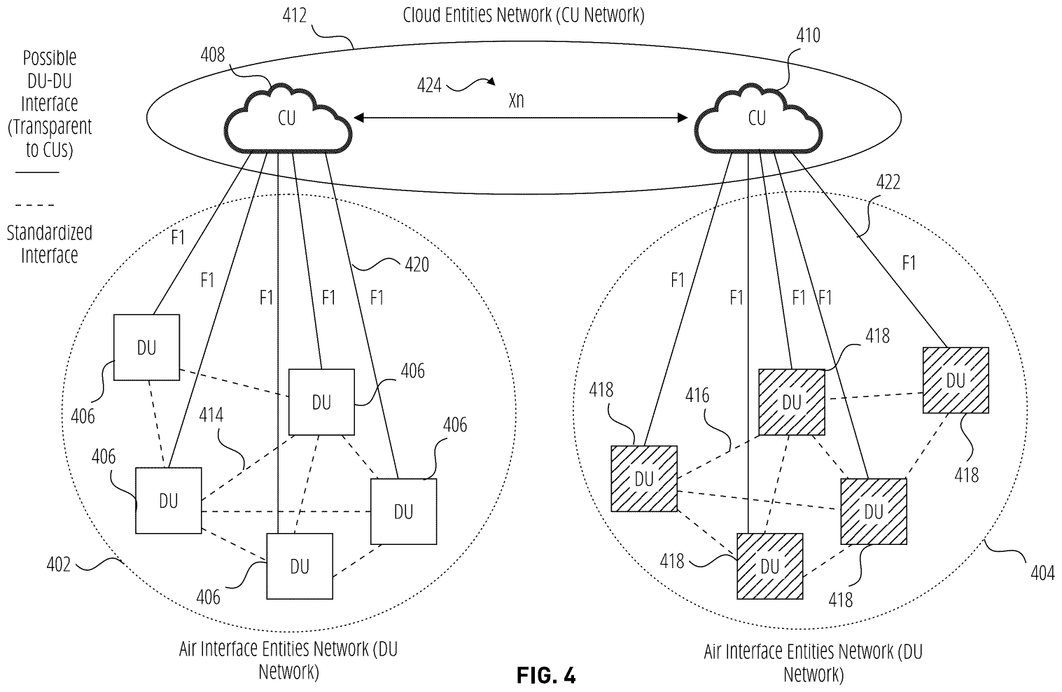

FIG. 4 illustrates an example of a 6G network architecture. A cloud entities network 412 includes a first CU 408 and a second CU 410 that communicate with each other over an Xn interface 424.

A first air interface entities network 402 includes first DUs 406 that are interconnected using first DU-DU interfaces 414 and that are connected via a first standardized interfaces 420 to the first CU 408.

A second air interface entities network 404 includes second DUs 418 with a second DU-DU interfaces 416 that are connected via second standardized interfaces 422 to the second CU 410.

### Embodiments for DU-DU Interfaces in Cell-Free Networks

In cell-free networks, a UE connects to multiple DUs that form multiple DU networks that are mainly managed by different CUs that form a CU network (and that are interconnected via standardized Xn interfaces). These networks might be provided by different vendors.

Without any DU-DU interface, a communication link between DUs (either in the case of static DUs like the case in TN (terrestrial network) or dynamic DUs like the case in NTN) is not possible, even via the CU. This limitation requires all scheduling and coordination to be handled by the CU through the F1 interface, resulting in latencies, particularly for real-time applications. This inefficiency is further pronounced in a multi-vendor environment where DUs and CUs from different vendors struggle to communicate effectively.

Proprietary DU-DU interfaces are typically transparent to the CU, which limits the CU's and UE's capabilities to leverage DU-DU communications effectively, thus impacting QoS.

In cell-free networks, DUs may be equipped with their own logic that is assumed to be able to configure transmission reception points (TRPs) of other DUs through a DU-DU interface. This allows one DU to schedule data for TRPs of other DUs. However, this process may be transparent to the CU in the case of proprietary DU-DU interface.

Further, the CU configures DUs (e.g., with associated MAC entities) for a UE based on one or more measurements and latency.

Accordingly, it is beneficial to make the CU aware of the DU-DU interface's existence and properties such that it can dynamically manage MAC entities for proper coordination. This may imply the use of a standardized DU-DU interface.

As one example, consider a 2-DU cell-free network (that includes DU1 and DU2), where the CU determines the latency needed for DU1 to communicate with TRPs of other DUs (e.g., TRP2). If the latency is within QoS limits, the CU can allow DU1 to communicate with TRP2 via DU-DU interface without creating a separate MAC entity at DU2. On the other hand, if the latency is not within QoS limits, the CU can instead dynamically create a separate MAC entity at DU2. Note that variable or dynamic latencies are expected in, in particular, NTN cases.

### Energy Efficiency Aspects for DU-DU Interfaces

The implementation of energy-efficient DU-DU interfaces in cell-free networks may be beneficial. Given the fact that a DU-DU interface might not be need to be required all of the time (for example, corresponding to certain circumstances for UE mobility, traffic QoS, or satellite mobility), the use of an energy-efficient DU-DU interface in cell-free networks primarily can promote enhanced energy efficiency and effective coordination. Two aspects can aid in achieving the target of an energy-efficient DU-DU interface. First, DU-DU interfaces that use dynamic states can be implemented. Secondly, related mechanisms for DU-DU interface state coordination and updating can be implemented.

Dynamic state DU-DU interfaces that allow for dynamic adjustment of the DU-DU interface state based on network demand and/or link conditions can significantly reduce energy consumption. Transitioning the DU-DU interface between states allows the network to conserve energy, for example, during low-demand periods or when certain links are less needed.

Further, since a CU/cloud entity should be aware of the existence and properties of DU-DU links in order to effectively manage resources and establish MAC entities, in dynamic environments like NTN, where link conditions vary frequently, the provision of up-to-date information on DU-DU link states can be helpful for efficient resource management.

Various embodiment for cell-free design relate to supporting connectivity of a device (a UE) with multiple DUs to achieve seamless connectivity, while making multiple DUs to operate as a single logical cell. However, as discussed herein, the absence of a standardized DU-DU interface imputes inefficiencies and increased latency onto the system. Note that this may be particularly problematic for real-time applications. Further, this challenge may be particularly pronounced in multi-vendor environments where interoperability issues arise.

The use of a standardized dynamic state DU-DU interface is helpful to ensure a certain level of efficient cross-DU communication, coordinated scheduling, and effective interference management within the system. Additionally, such a DU-DU interface may dynamically adjust network operations to improve energy consumption and performance, which differentiates it from traditional stateless interfaces.

A novel, dynamic, and energy-efficient logical DU-to-DU interface can be defined to support advanced cell-free features. Herein, such a DU-DU interface may be referred to as an eXn interface.

### eXn Interface—Definitions, Conditions, and Benefits

An eXn interface may be defined as a direct logical communication interface between DUs/air interface entities (DU-to-DU) within a cell-free network architecture. Its primary role is to enable efficient, direct data exchange and coordination between DUs, which may bypass the hierarchical route through the CU/cloud entity.

In some embodiments, an eXn interface may be allowed between DUs that are either connected to a same CU or, in some embodiments, to the same CU network. In various examples provided herein, an eXn interface is described as between DUs that are connected to a same CU. Note that as a general matter, analogous examples could further be derived and implemented for cases where the DUs are instead connected to different respective CUs of a same CU Network.

In various embodiments, DUs can be either an initiator (an initiator DU or initiator air interface entity) or responder (a responder DU or a responder air interface entity) of/on the eXn interface. These designations may be based on a CU's/cloud entity's role assignment orchestration. In some embodiments, eXn interface operations can be coordinated by either one of participating DUs (e.g., an initiator DU) or by a coordinator CU connected to the participating DUs. In some embodiments, upon failure, DU-DU communications may fall back to a traditional hierarchical route through the CU.

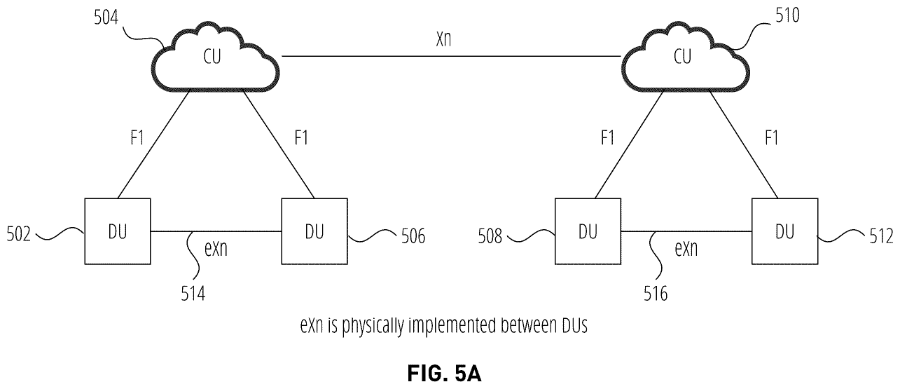

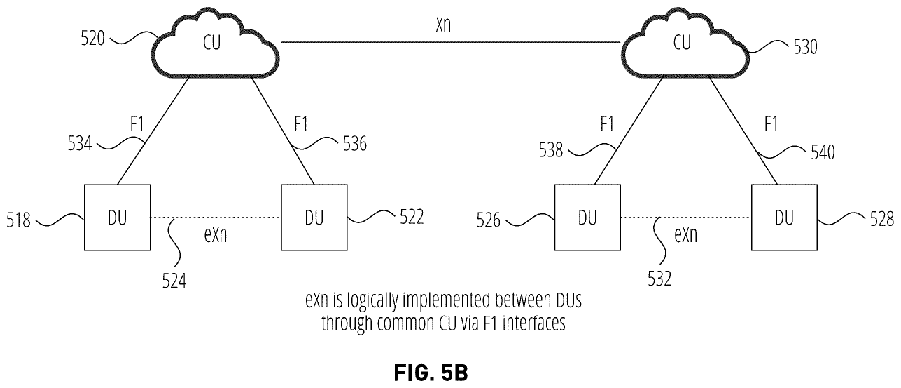

FIG. 5A illustrates an example of eXn interface use, according to embodiments discussed herein. A first DU 502 (or air interface entity) is connected to a first CU 504 (or cloud entity). A second DU 506 is connected to the first CU 504. A first eXn interface 514 is physically implemented between the first DU 502 and the second DU 506.

Further, a third DU 508 is connected to a second CU 510. A fourth DU 512 is connected to the second CU 510. A second eXn interface 516 is physically implemented between the third DU 508 and the fourth DU 512.

FIG. 5B illustrates an example of eXn interface use, according to embodiments discussed herein. A first DU 518 (or air interface entity) is connected to a first CU 520 (or cloud entity). A second DU 522 is connected to the first CU 520. A first eXn interface 524 is logically implemented between the first DU 518 and the second DU 522 via a first F1 interface 534 and a second F1 interface 536.

A third DU 526 is connected to a second CU 530. A fourth DU 528 is connected to the second CU 530. A second eXn interface 532 is logically implemented between the third DU 526 and the fourth DU 528 via a third F1 interface 538 and a fourth F1 interface 540.

In some embodiments implementing a cell-free network architectures, the eXn interface may include a direct communication path, which may break traditional hierarchical routes, facilitating direct coordination between DUs/air interface entities. The eXn interface may reduce latency within the system through the use of direct DU-DU communication, thus minimizing latency attributable, for example, synchronized and time-sensitive operations. The eXn interface may include resource management and load balancing features which may enhance dynamic resource sharing and workload distribution among DUs, improving network capacity and responding effectively to varying traffic demands. The eXn interface may include distributed multiple input multiple output (MIMO) support by facilitating coordination needed for distributed MIMO (e.g., for joint transmission, reception, and/or beamforming), thereby enhancing overall network efficiency and user experience.

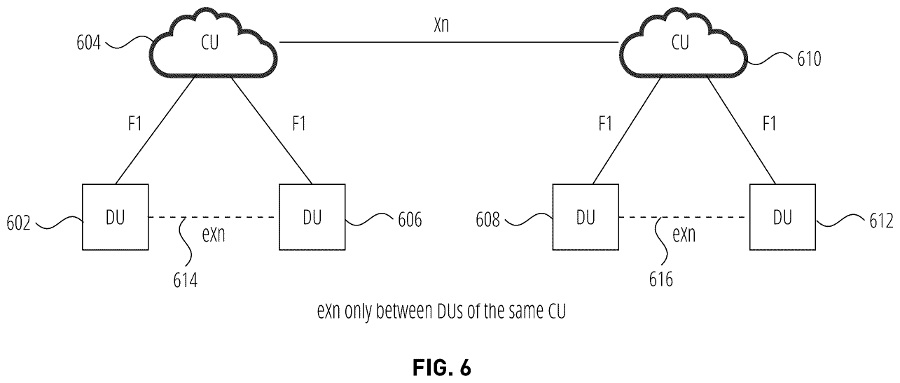

FIG. 6 illustrates an example of eXn interface use, according to embodiments discussed herein. A first DU 602 (or air interface entity) is connected to a first CU 604 (or cloud entity). A second DU 606 is connected to the first CU 604. A first eXn interface 614 is physically implemented between the first DU 602 and the second DU 606.

Further, a third DU 608 is connected to a second CU 610. A fourth DU 612 is connected to the second CU 610. A second eXn interface 616 is physically implemented between the third DU 608 and the fourth DU 612.

The embodiment shown in FIG. 6 is consistent with a sub-case for embodiments discussed herein, where eXn interfaces are implemented between DUs of a same CU.

In some embodiments implementing a cell-free network architecture, the eXn interface may be used for coordinated scheduling. The eXn interface may enable DUs to share and synchronize scheduling decisions directly, reducing latency and improving resource utilization.

The eXn interface may be used for measurements sharing. The eXn interface may facilitate the exchange of performance data between DUs in real-time, enhancing cross-DU coordination and resource management.

The eXn interface may be used for TRP coordination. The eXn interface may allow/be used by one DU to control the TRPs of other DUs, thereby optimizing coverage and capacity management.

The eXn interface may be used for interference management. The eXn interface may enable the management and mitigation of interference between DUs (e.g., through real-time communication), thereby increasing the likelihood of stable and reliable connections.

The eXn interface may be used for dynamic resource allocation. The eXn interface may be used as a support for the dynamic allocation of resources between DUs with high-speed data links and advanced algorithms, thereby increasing the system's ability to adapt to changing network conditions.

The eXn interface may be used for load balancing and traffic management. The eXn interface may be used to distribute traffic loads evenly across multiple DUs with intelligent load-balancing algorithms, preventing bottlenecks and increasing the likelihood of smooth traffic flow.

### Embodiments for eXn Interface States

In some embodiments, an eXn interface state may be understood as a dynamically changeable operational state of the eXn interface. An eXn interface may adopt one of three such operational states: an ACTIVE state, a STANDBY state, or an INACTIVE state.

The ability to dynamically adjust an eXn interface state based on network demand and link conditions may improve overall network energy efficiency. By transitioning an eXn interface between ACTIVE, STANDBY, and INACTIVE states as needed, the network may optimize energy consumption (for example, during periods of low demand or when certain links may be less needed).

An eXn interface “ACTIVE” state may be defined as a fully-operational mode corresponding to full operational capability and configurability. The ACTIVE state may facilitate direct and improved DU-to-DU communication between participating DUs (or air interface entities) of the eXn interface. In some embodiments, a node that triggers a transition to the ACTIVE state may be a coordinator CU that is connected to the participating DUs of the eXn interface.

In some embodiments, criteria for transitioning an eXn interface into the ACTIVE state may include a latency threshold and/or a network demand. With respect to a latency threshold it may be that activation is contingent on the condition that the eXn interface's latency is lower than the traditional hierarchical route through the CU (e.g., through Xn and F1 interfaces). With respect to a network demand, it may be that activation is contingent on specific network needs for enhanced DU-to-DU coordination.

Operational characteristics of an eXn interface ACTIVE state may include full DU-to-DU communication and/or continuous monitoring. Full DU-to-DU communication may be defined as a case in which all designed functionalities, such as load balancing, resource sharing, and signal coordination, are active. Continuous monitoring may be defined as a case where real-time monitoring of eXn interface performance is performed by the coordinating CU to ensure ongoing compliance with QoS standards.

An eXn interface “STANDBY” state may be defined as a resource-efficient and less-operational (relative to the ACTIVE state), yet ready mode, wherein the eXn interface remains configured and ready but may not be presently under active use for DU-to-DU communications. In some embodiments, a node that triggers the a transition to the STANDBY state may be a coordinator CU connected to the participating DUs of the eXn interface.

In some embodiments, criteria for transitioning an eXn interface to the STANDBY state may include a reduced network demand. For example, an eXn interface may enter the STANDBY state when a demand for direct DU-to-DU communication is temporarily reduced or non-critical. This STANDBY state is conserves resources and/or reduce operational overhead relative to an ACTIVE state for cases when direct DU-to-DU interaction is less frequent.

In some embodiments, the eXn interface STANDBY state may incorporate maintenance of configuration and/or reduced activity relative to an ACTIVE state. Maintenance of configuration means the eXn interface retains its configuration settings and parameters for a swift transition back to ACTIVE state when needed. Reduced activity means that no active DU-to-DU communication occurs, but that the interface can be reactivated as needed to allow for such active DU-to-DU communication.

An eXn interface “INACTIVE” state may be defined as a non-operational mode, where the eXn interface is not yet be configured and therefore is not actively used for DU-to-DU communication. The reactivation of a previously ACTIVE eXn interface that has since fallen to the INACTIVE state may correspond to a more comprehensive reactivation process than that for an eXn interface that has fallen only to a STANDBY state from the ACTIVE state. In some embodiments, a note that triggers a transition to the INACTIVE state may be a coordinator CU connected to the participating DUs of the e Xn interface.

In some embodiments, criteria for transitioning an eXn interface to the INACTIVE state may include latency constraints. For example, the transition occurs if the eXn interface's latency exceeds a predefined threshold such that hierarchical communication via CU is more efficient.

In some embodiments, the eXn interface INACTIVE State may use no active communication. The eXn interface ceases to facilitate active communication between DUs. Further, with respect to readiness for reactivation, it is noted that reactivation from the INACTIVE state may use a more comprehensive re-initialization process compared to the case for re-activation from a STANDBY state to the ACTIVE state.

In some embodiments, state transition procedures may be defined as the set of procedures to be adopted to transition between the eXn interface operational states-INACTIVE, ACTIVE, and STANDBY-which may be controlled by two procedures: an interface setup and reactivation (ISR) procedure and eXn interface suspension and termination (IST) procedure.

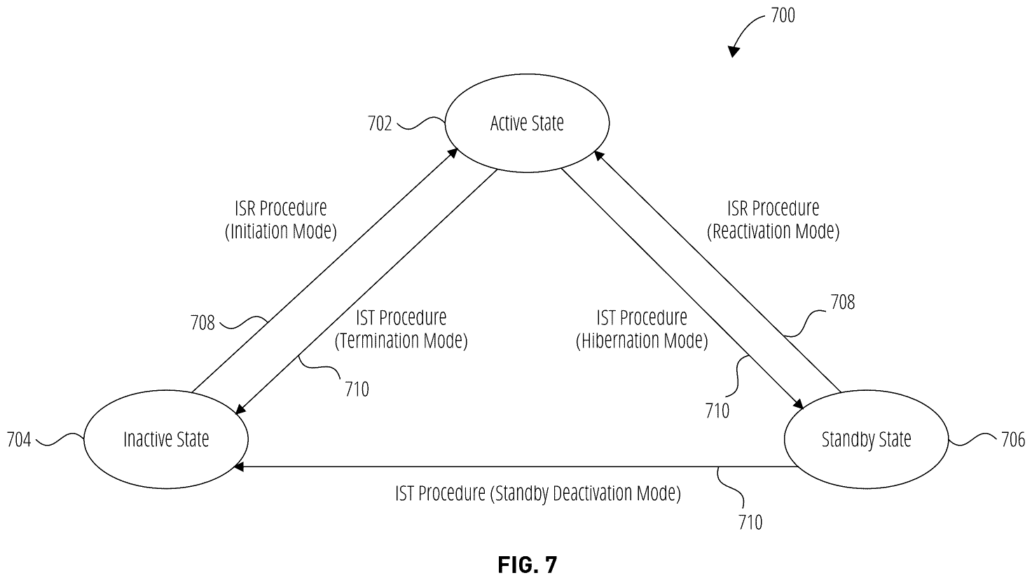

FIG. 7 illustrates a state machine 700 for transitioning an eXn interface as between an ACTIVE state 702, an INACTIVE state 704 and a STANDBY state 706, according to embodiments discussed herein.

An eXn interface may transition from the INACTIVE state 704 to the ACTIVE state 702 according to an ISR procedure 708 (in an initiation mode).

An eXn interface may transition from the STANDBY state 706 to the ACTIVE state 702 according to the ISR procedure 708 (in a reactivation mode).

An eXn interface may transition from the ACTIVE state 702 to the INACTIVE state 704 according to the IST procedure 710 (in a termination mode).

An eXn interface may transition from the STANDBY state 706 to the INACTIVE state 704 according to the IST procedure 710 (in a standby deactivation mode).

An eXn interface may transition from the ACTIVE state 702 to the STANDBY state 706 according to the IST procedure 710 (in a hibernation mode).

A state transition from an INACTIVE state to an ACTIVE state is now discussed. In some embodiments, a trigger for a state transition procedure from an INACTIVE state into an ACTIVE state may be a network demand and/or favorable latency conditions.

The procedure used for the transition may be an ISR procedure in an initiation mode. The procedure may be triggered by a CU (or cloud entity). The procedure may include an initiation by a designated initiator DU (an initiator air interface entity) to engage in discovery and negotiation with adjacent DUs. Then, capability assessment and parameter setting are followed by a mutual handshake for operational readiness. The involved network nodes may include an initiator DU and one or more adjacent DUs, as coordinated by the CU.

A state transition from a STANDBY state to an ACTIVE state is now discussed. In some embodiments, a trigger for a state transition procedure from a STANDBY state into an ACTIVE state may be a resurgence of network demand and/or improved conditions.

The procedure used for the transition may be an ISR procedure in a reactivation mode. The procedure may be triggered by a CU. The procedure may include a reactivation protocol that performs a relatively streamlined reactivation based on previously retained configurations. Functional checks and operational handshakes may be used to ensure readiness. The involved network nodes may include DUs of the cXn interface that is transitioning from the STANDBY state to the ACTIVE state, potentially as coordinated by the CU.

A state transition from an ACTIVE state to an INACTIVE state is now discussed. In some embodiments, a trigger for a state transition procedure from an ACTIVE state into an INACTIVE state may be an increase in latency and/or a reduction in network demand.

The procedure used for the transition may be an IST procedure in a termination mode. The procedure may be triggered by a CU. The procedure may include a termination protocol initiation by a designated DU and data preservation and session closure, followed by collective deactivation and ultimately transition to the INACTIVE state. The involved network nodes may include DUs for the eXn interface that is transitioning from the ACTIVE to INACTIVE state, potentially as coordinated by the CU.

A state transition from a STANDBY state to an INACTIVE state is now discussed. In some embodiments, a trigger for the state transition procedure from a STANDBY state into an INACTIVE state may include long-term inactivity and/or strategic network reconfiguration.

The procedure used for the transition may be an IST procedure in a standby deactivation mode. The procedure may be triggered by a CU. The procedure may include a formal deactivation process initiated from the STANDBY state and an ultimate transition to the INACTIVE state, while preparing for comprehensive re-initialization if needed (e.g., by storing configuration information for the eXn interface for later use). The involved network nodes may include the DUs of the eXn interface that is transitioning from the STANDBY state to INACTIVE state, potentially as coordinated by the CU.

A state transition from an ACTIVE state to a STANDBY state is now discussed. In some embodiments, a trigger for a state transition procedure from an ACTIVE state into a STANDBY state may include reduced network demand and/or strategic decisions.

The procedure used for the transition may be an IST procedure in a hibernation mode. The procedure may be triggered by a CU. The procedure may include a reduction in operational activities, while maintaining configuration information for purposes of swift reactivation, and ultimately a transition to a low-activity STANDBY state to conserve resources. The involved network nodes may include DUs of the eXn interface that is transitioning from the ACTIVE state to the STANDBY state, potentially as coordinated by the CU.

### Embodiments for Roles and Responsibilities of CUs and DUs

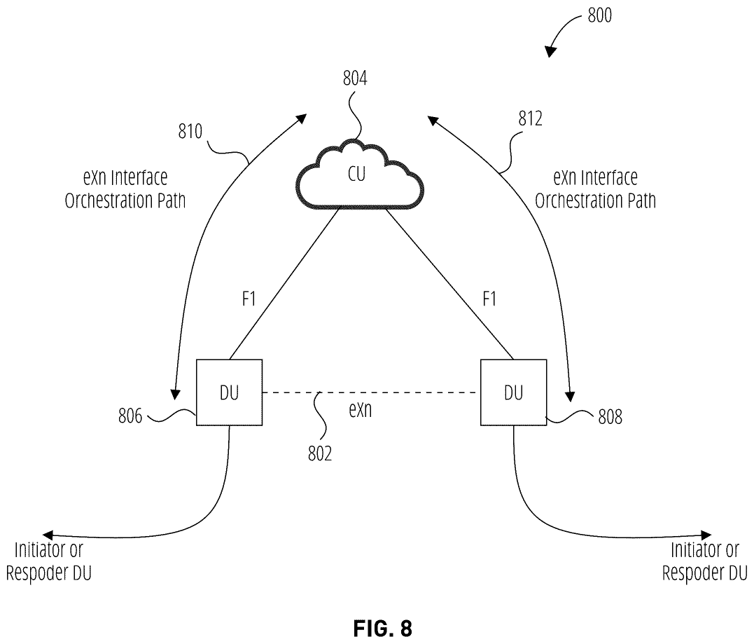

FIG. 8 illustrates an example network architecture 800 showing various of roles and responsibilities of various network entities corresponding to an eXn interface 802, according to embodiments discussed herein. Each of the first DU 806 (or air interface entity) and the second DU 808 are connected to a coordinator CU 804 (or coordinator cloud entity).

One of the first DU 806 and the second DU 808 may be an initiator DU, while the other of the first DU 806 and the second DU 808 may be a responder DU. The first DU 806 and the second DU 808 are connected via the eXn interface 802.

The coordinator CU 804 may manage the eXn interface 802 via the first DU 806 and the second DU 808. Corresponding to this ability, it may be understood that there is a first eXn orchestration path 810 between the coordinator CU 804 and the first DU 806 and a second eXn orchestration path 812 between the coordinator CU 804 and the second DU 808.

Various embodiments herein contemplate that an eXn interface may be managed by a coordinator CU. The coordinator CU of the eXn interface may implement holistic network optimization by utilizing its relatively more comprehensive understanding of the system to optimize eXn interface usage, thereby enhancing efficiency within the overall cell-free network.

A coordinator CU may implement strategic role allocation and oversight. The coordinator CU may be configured to assign and oversee roles of DUs as initiators or responders, in light of a larger network strategy.

A coordinator CU may be a source of decisive action in interface management dynamics within the system. The coordinator CU may play a role in deciding and initiating transitions between ACTIVE, STANDBY, and INACTIVE states of an eXn interface, based on network performance metrics and demands.

A coordinator CU may perform eXn interface performance management and evaluation. The coordinator CU monitors and assesses eXn interface performance, ensuring alignment with applicable standards/metrics for the cell-free network.

A coordinator CU may operate using dynamic state status update requests. These requests may be used by the coordinator CU to retrieve up-to-date information on the state of an eXn interface to enable it to manage resources efficiently.

Various embodiments discussed herein contemplate activities of an initiator DU for an eXn interface. An initiator DU may provide eXn interface initiation and reactivation leadership. The initiator DU initiates the setup or reactivation of the eXn interface, setting the stage for enhanced DU-to-DU coordination and communication.

An initiator DU may perform strategic communication management. The initiator DU manages the exchange of control messages such as discovery requests, messages negotiating operational parameters, and messages for security and authentication establishment with adjacent and relevant DUs for efficient eXn interface setup.

An initiator DU may be a source of decisive action in eXn interface management dynamics within the system. The initiator DU may play a role in deciding and initiating transitions between ACTIVE, STANDBY, and INACTIVE states of an cXn interface, based on network performance metrics and demands.

An initiator DU may perform eXn interface performance management and evaluation. The initiator DU may monitor and assess an eXn interface's performance, ensuring alignment with applicable standards/metrics for the cell-free network.

The initiator DU may further operate using dynamic state status update messages. These message may be used to communicate up-to-data information on the state of DU-DU links to a CU to enable the efficient management of resources.

Various embodiments discussed herein contemplate activities of a responder DU for an eXn interface. A responder DU may provide for responsive eXn interface engagement. The responder DU may efficiently respond to initiation or reactivation signals from an initiator DU, thereby promoting agile network operations.

A responder DU may provide participatory network analysis and feedback. The responder DU is actively involved in network analysis, contributing valuable insights for optimal eXn interface deployment and maintenance.

A responder DU may participate in joint parameter negotiation and finalization. The responder DU collaborates in negotiating operational parameters, playing a role in finalizing settings that align with objectives for the cell-free network.

A responder DU may engage in security collaboration and compliance. The responder DU actively engages in establishing and maintaining security protocols, ensuring secure DU-DU communication within the cell-free framework.

A responder DU may play an adaptive role in network dynamics. The responder DU may flexibly adjust for operational status changes and role allocations for an eXn interface in response to changing network conditions, instructions from the CU, or triggers from an initiator DU.

### Embodiments of ISR Procedures

In some embodiments, an eXn ISR procedure may be defined as a sequence of protocols that efficiently facilitates transitions of an eXn interface to an ACTIVE state An ISR procedure may adopt or be used according to two operational modes: an initialization mode and/or a reactivation mode.

In some embodiments, an initialization mode of an ISR procedure may be defined for use when an eXn interface is set up for the first time or after a prior eXn interface is in an INACTIVE state—conditions where a “full” setup process is called for. In the initialization mode, the ISR procedure begins with a series of steps to ensure a proper initialization of the eXn interface, including discovery of adjacent DUs, negotiation of operational parameters, full security setup (authentication and encryption), and final activation in order to establish the eXn interface. This ensures that the eXn interface is ready for operation.

In some embodiments, a reactivation mode of an ISR procedure may be defined for use when reactivating the eXn interface from a STANDBY state or a reduced functionality state, where the essential configurations have been previously retained but are not actively being used. In the reactivation mode, the ISR procedure begins with rapid retrieval and reinstatement of previously stored operational settings. Security credentials and settings are reviewed and updated as needed. This is followed by a formal signal reactivates the eXn interface, re-establishing communication between the DUs.

In some embodiments, the eXn ISR procedure can adopt a sequence of four protocols that are used for each of the initialization and reactivation modes. This sequence of four protocols may be used to ensure a fluid and efficient transition of an cXn interface across different operational states.

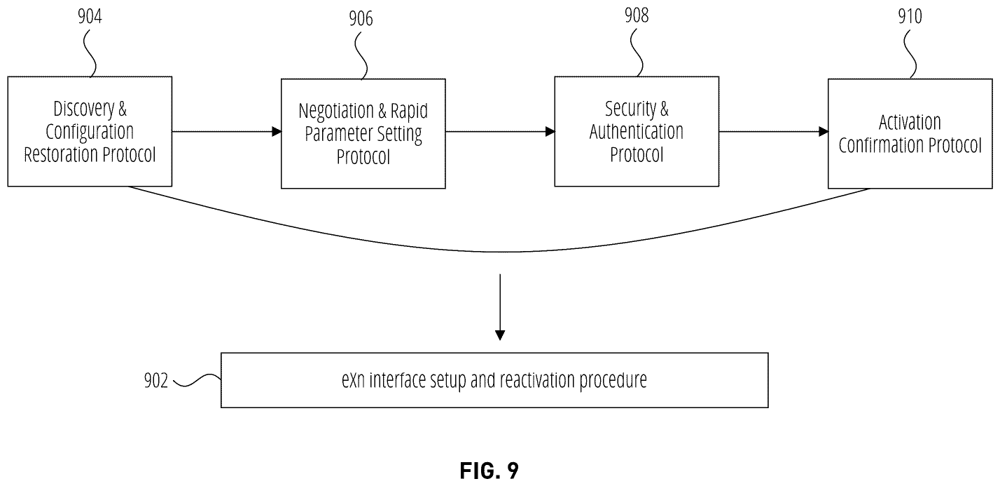

FIG. 9 illustrates an example eXn ISR procedure 902, according to embodiments discussed herein. The eXn ISR procedure 902 includes a discovery and configuration restoration protocol 904, a negotiation and rapid parameter setting protocol 906, a security and authentication protocol 908, and an activation confirmation protocol 910.

A discovery and configuration restoration protocol 904 may be used to identify adjacent DUs and swiftly reinstating saved configurations to establish or reactivate the cXn interface.

A negotiation and rapid parameter setting protocol 906 may be used to facilitate swift agreement on operational parameters like bandwidth and latency, and may be tailored for both initial setup and reactivation scenarios.

A security and authentication protocol 908 may be used to ensure secure communications by establishing mutual authentication and setting encryption parameters, and may be adaptable for both initial setups and reactivations.

An activation confirmation protocol 910 may be used to finalize the eXn interface activation ensuring optimal performance post-setup or reactivation.

Embodiments for a discovery and configuration restoration protocol (such as the discovery and configuration restoration protocol 904) are now discussed.

In some embodiments, a discovery and configuration restoration protocol is a component of ISR procedure that operates differently depending on whether the ISR procedure executes in an initialization mode or in a reactivation mode. For both modes, the discovery and configuration restoration protocol is defined to ensure efficient communication setup and coordination between DUs, aligning operational parameters to create a cohesive network fabric.

When the ISR procedure is in the initialization mode, the objective of the discovery and configuration restoration protocol is to identify and establish initial communication between neighboring DUs in the network. In one embodiment, the initiator DU broadcasts a discovery signal containing its identifier (ID) and its basic capabilities. Neighboring DUs may receive this signal and respond with their own IDs and capabilities. Using this information, an initiator DU ensures the compatibility of software versions, operational capabilities, and available resources as between neighboring DUs.

When the ISR procedure is in the reactivation mode, the objective of the discovery and configuration restoration protocol is to quickly restore an eXn interface to its operational (ACTIVE) state using previously saved configurations. An initiator DU broadcasts a reactivation signal to inform neighboring DUs of reactivation request containing. This reactivation signal identifies a latest stored configuration. Then, adjacent DUs acknowledge the reactivation and confirm their compatibility readiness to resume operations under the restored configurations.

In some embodiments of the discovery and configuration restoration protocol according to the initialization mode of the ISR, a discovery signal broadcast request may be transmitted from the initiator DU to the responder DUs. The discovery signal broadcast request may include a DU ID that is a unique identifier for the initiator DU. The discovery signal broadcast request may include a request ID that is a unique identifier of the initiation request. The discovery signal broadcast request may include details on supported bandwidth capabilities for understanding potential data transfer rates. The discovery signal broadcast request may include information on the initiator DU's data processing abilities. The discovery signal broadcast request may indicate a current software version of the initiator DU that may be used for compatibility checks.

In some embodiments of the discovery and configuration restoration protocol according to the initialization mode of the ISR, a discovery signal broadcast response may be transmitted from responder DUs to an initiator DU. The discovery signal broadcast response may include a DU ID that is a unique identifier for the responder DU. The discovery signal broadcast response may include a request ID that is a unique identifier of the initiation request. The discovery signal broadcast response may include an acknowledgment of a discovery signal transmitted by the initiator DU, which acts as a confirmation that the discovery signal was received. The discovery signal broadcast response may include bandwidth and data processing capabilities of the responding DU. The discovery signal broadcast response may include a compatibility status that indicates whether the responding DU is compatible with the initiator DU based on the software version and operational capabilities indicated by the initiator DU.

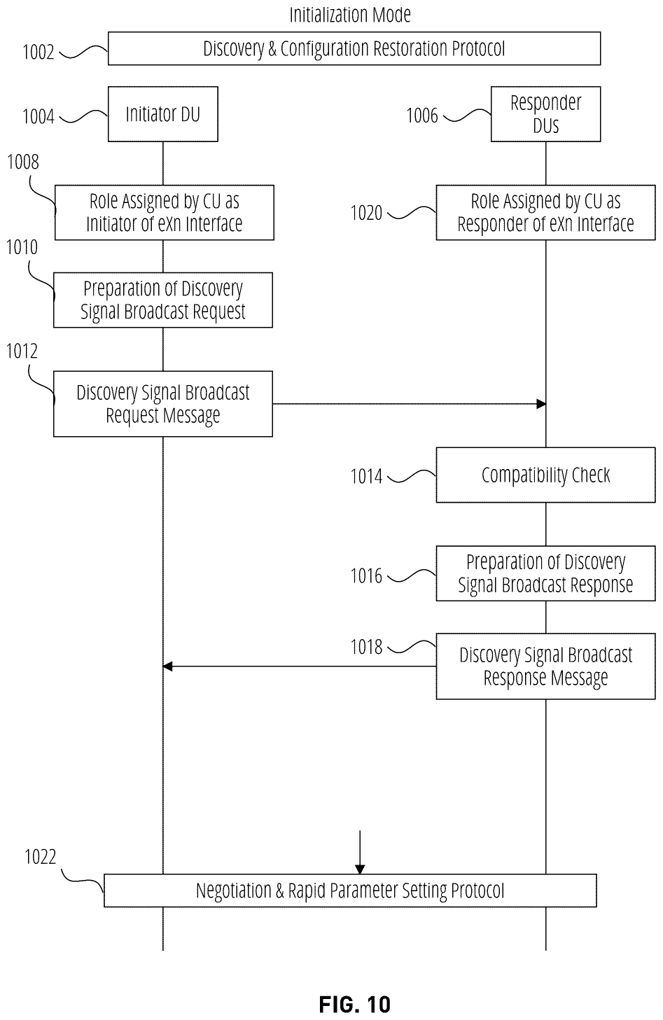

FIG. 10 illustrates an example of a discovery and configuration restoration protocol 1002 operating according to an initialization mode of an ISR, according to embodiments discussed herein. An initiator DU 1004 (the initiator air interface entity) is assigned 1008 a role by a CU (a cloud entity) as initiator of cXn interfaces with the responder DUs 1006 (responder air interface entities). The initiator DU 1004 prepares 1010 the discovery signal broadcast request message and transmits 1012 a corresponding discovery signal broadcast request message to the responder DUs 1006 which have been assigned 1020 a role by the CU as responders of an eXn interface with the initiator DU 1004. The responder DUs 1006 each execute a compatibility check 1014 and prepare 1016 a discovery signal broadcast response message that they then transmit 1018 back to the initiator DU 1004. The discovery and configuration restoration protocol 1002 is followed by a negotiation and rapid parameter setting protocol 1022.

In some embodiments of the discovery and configuration restoration protocol according to the reactivation mode of an ISR, a reactivation request may be transmitted from the initiator DU to the responder DUs. The reactivation request may include a DU ID that is a unique identifier for the initiator DU. The reactivation request may include a request ID that is a unique identifier of the reactivation request. The reactivation request may include a last active request ID, which is a unique identifier of the latest activation/reactivation request that can be used to restore the latest saved configurations linked to this activation/reactivation request ID. The reactivation request may include a reactivation inquiry that acts as an indication that the initiator DU intends to reactivate a previously ACTIVE eXn interface.

In some embodiments of the discovery and configuration restoration protocol according to the reactivation mode, a reactivation response may be transmitted from the responder DUs to the initiator DU. The reactivation response may include a DU ID that is a unique identifier for the responder DU. The reactivation response may include a request ID that is a unique identifier of the reactivation request. The reactivation response may include a last active request ID which is a unique identifier of the latest activation/reactivation request that can be used to restore the latest saved configurations linked to this latest request ID. The reactivation response may include a confirmation of configuration restoration that acts as an acknowledgment the latest stored configuration details are restored and understood. The reactivation response may include a readiness status that is a confirmation of their compatibility readiness to resume operations under the restored configurations.

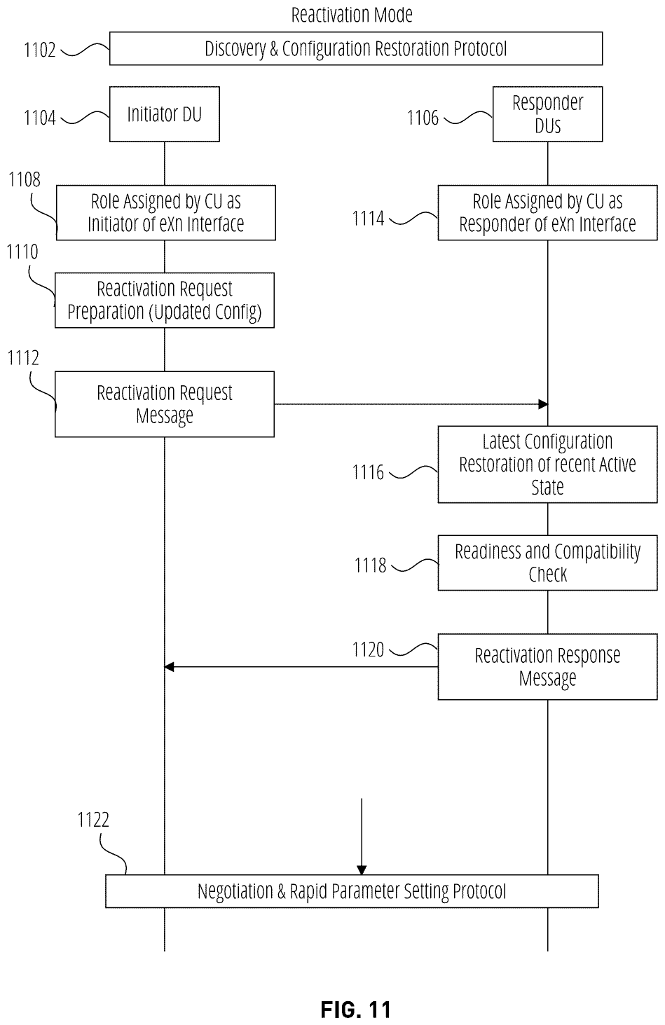

FIG. 11 illustrates example of a discovery and configuration restoration protocol 1102 operating according to a reactivation mode of an ISR, according to embodiments discussed herein. An initiator DU 1104 (the initiator air interface entity) is assigned 1108 a role by a CU (a cloud entity) as of eXn interfaces with the responder DUs 1106 (responder air interface entities). The initiator DU 1104 prepares 1110 a reactivation request (potentially indicating updated configuration in formation) and transmits 1112 a corresponding reactivation request message to the responder DUs 1106 which have been assigned 1114 a role by the CU as responders of an eXn interface with the initiator DU 1104. The responder DUs 1106 each restore 1116 a latest configuration of a recent ACTIVE state and execute a readiness and compatibility check 1118. The responder DUs 1106 then transmit 1120 a reactivation response message to the initiator DU 1104. The discovery and configuration restoration protocol 1102 is followed by a negotiation and rapid parameter setting protocol 1122.

Embodiments for a negotiation and rapid parameter setting protocol (such as the negotiation and rapid parameter setting protocol 906) are now discussed.

In one embodiment, a negotiation and rapid parameter setting protocol may facilitate the negotiation of operational parameters and their rapid setting or adjustment for both initialization and reactivation modes of an ISR. In both modes, the negotiation and rapid parameter setting protocol ensures that the operational parameters of the eXn interface are optimally set for efficient DU-DU communication and coordination, either through thorough negotiation when in the initialization mode e or rapid restoration and adjustment when in the reactivation mode.

When the ISR is in the initialization mode, the objective of the negotiation and rapid parameter setting protocol is to negotiate and set optimal operational parameters for a newly established eXn interface. An initiator DU sends out a parameter proposal to adjacent DUs, detailing suggested parameters like bandwidth allocation, latency targets, and synchronization specifics. A collaborative negotiation occurs in which adjacent DUs respond with feedback, amendments, or approval. This collaborative negotiation aims to reach a consensus that suits both individual DU needs and overall network efficiency. Finally a parameter exchange and confirmation ensures that final agreed parameters are exchanged and confirmed among all involved DUs.

When the ISR is in the reactivation mode, the objective of the negotiation and rapid parameter setting protocol is to rapidly restore, adjust, and set operational parameters based on pre-saved configurations, ensuring a swift reactivation of an eXn interface. A review of saved parameters is performed, where the initiator DU reviews previously saved configurations to determine if they are still valid under current network conditions. Then, if necessary, the initiator DU makes rapid adjustments to the parameters, informed by the latest network status and demands. The initiator DU then performs parameter broadcasting, in which updated parameters are quickly broadcasted to adjacent DUs for immediate implementation. Finally, quick consensus and activation is reached with adjacent DUs, in which adjacent DUs quickly align and confirm these parameters, allowing for a speedy transition back to an ACTIVE state.

In some embodiments of the negotiation and rapid parameter setting protocol according to the initialization mode of an ISR, a parameter proposal request may be transmitted from the initiator DU to the responder DUs. The parameter proposal request may include a DU ID that is a unique identifier for the initiator DU. The parameter proposal request may include a request ID that is a unique identifier of the initiation request. The parameter proposal request may include proposed operational parameters which may include detailed suggestions for bandwidth allocation, latency targets, synchronization details, etc. The parameter proposal request may include a request to provide feedback or counter-proposals, if any.

In some embodiments of the negotiation and rapid parameter setting protocol according to the initialization mode of the ISR, parameter proposal feedback may be transmitted from the responder DUs to the initiator DU. The parameter proposal feedback may include a DU ID that is a unique identifier for the responder DU. The parameter proposal feedback may include a request ID that is a unique identifier of the initiation request. The parameter proposal feedback may include feedback on proposed parameters, which may include specific responses (approvals, amendments, or rejections) to the operational parameters proposed by the initiator DU. The parameter proposal feedback may include counter-proposal details, including detailed descriptions of counter-proposed suggestions. The parameter proposal feedback may include DU-specific requirements that include each responding DU's individual needs or constraints that might influence negotiation.

In some embodiments of the negotiation and rapid parameter setting protocol according to the initialization mode of the ISR, a parameter proposal configuration request may be transmitted from the initiator DU to the responder DUs. The parameter proposal configuration request may include a DU ID that is a unique identifier for the initiator DU. The parameter proposal configuration request may include a request ID that is a unique identifier of the initiation request. The parameter proposal configuration request may include negotiated parameters and configurations that are the finalized set of operational parameters and configurations post-negotiation. The parameter proposal configuration request may include synchronization instructions that are specific instructions or parameters to ensure all DUs are aligned and synchronized. The parameter proposal configuration request may include a timestamp of finalization that is a timestamp of the final set of parameters and configurations.

In some embodiments of the negotiation and rapid parameter setting protocol according to the initialization mode of the ISR, a parameter proposal configuration response may be transmitted from the responder DUs to the initiator DU. The parameter proposal configuration response may include a DU ID that is a unique identifier for the responder DU. The parameter proposal configuration response may include a request ID that is a unique identifier of the initiation request. The parameter proposal configuration response may include an operational readiness signal, which is a readiness indication from each DU that they acknowledge the receipt of finalized parameters and are ready to operate under the agreed parameters. The parameter proposal configuration response may include a synchronization alignment which is a confirmation that all DUs are aligned and synchronized.

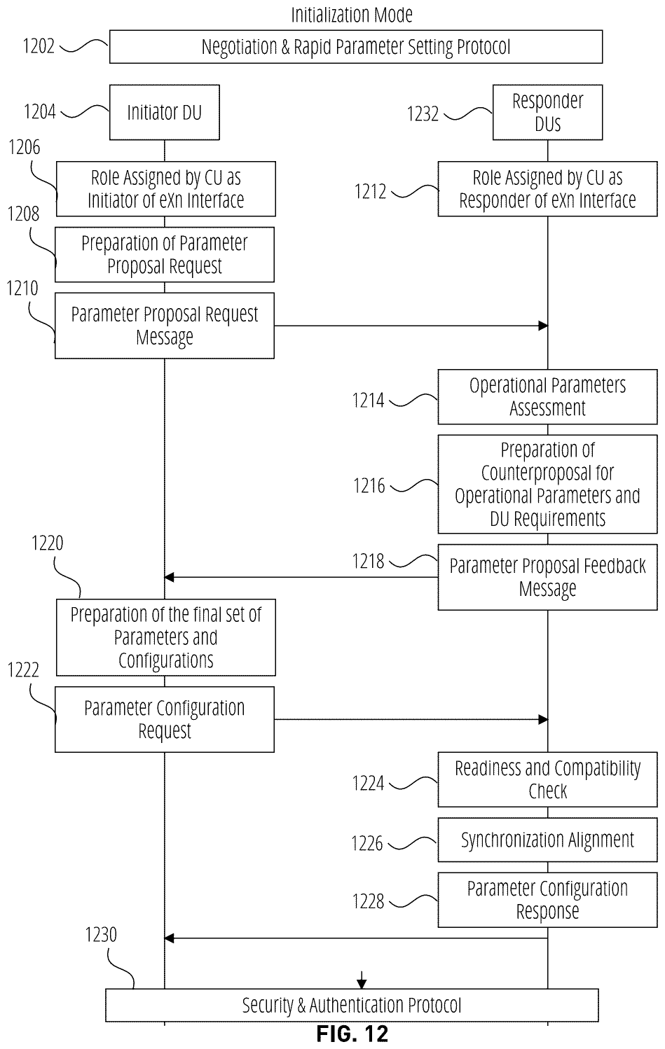

FIG. 12 illustrates an example of a negotiation and rapid parameter setting protocol 1202 according to an initialization mode of an ISR, according to embodiments discussed herein. The initiator DU 1204 (the initiator air interface entity) is assigned 1206 a role by a CU (a cloud entity) as initiator of eXn interfaces with the responder DUs 1232 (responder air interface entities). The initiator DU 1204 prepares 1208 a parameter proposal request and transmits 1210 corresponding parameter proposal request message to responder DUs 1232 that have been assigned 1212 a role by the CU as responders of an eXn interface with the initiator DU 1204. The responder DUs 1232 assess 1214 operational parameters and prepare 1216 a counterproposal for operational parameters and DU requirements. The responder DUs 1232 then transmit 1218 a parameter proposal feedback message representing the counterproposal to the initiator DU 1204.

Based on this information, the initiator DU 1204 prepares 1220 a final set of parameters and configurations and transmits 1222 a parameter configuration request containing this information to the responder DUs 1232. The responder DUs 1232 check 1224 readiness and compatibility and execute 1226 a synchronization alignment. The responder DUs 1232 then transmit 1228 a parameter configuration response to the initiator DU 1204. The negotiation and rapid parameter setting protocol 1202 is followed by a security and authentication protocol 1230.

In some embodiments of the negotiation and rapid parameter setting protocol according to the reactivation mode of the ISR, a rapid parameters adjustment request may be transmitted from the initiator DU to the responder DUs. The rapid parameters adjustment request may include a DU ID that is a unique identifier for the initiator DU. The rapid parameters adjustment request may include a request ID that is a unique identifier of the reactivation request. The rapid parameters adjustment request may include adjusted parameters that are a final set of operational parameters post-adjustment, ready for immediate implementation. The rapid parameters adjustment request may include an acknowledgment request that is a request for adjacent DUs to acknowledge receipt and readiness to implement these parameters.

In some embodiments of the negotiation and rapid parameter setting protocol according to the initialization mode, a rapid parameters adjustment response may be transmitted from the responder DUs to the initiator DU. The rapid parameters adjustment response may include a DU ID that is a unique identifier for the responder DU. The rapid parameters adjustment response may include a request ID that is a unique identifier of the reactivation request. The rapid parameters adjustment response may include a confirmation of parameters, which act as an acknowledgment from adjacent DUs confirming their agreement with the updated parameters The rapid parameters adjustment response may include a readiness status that is a confirmation of their compatibility readiness to resume operations under the updated configurations.

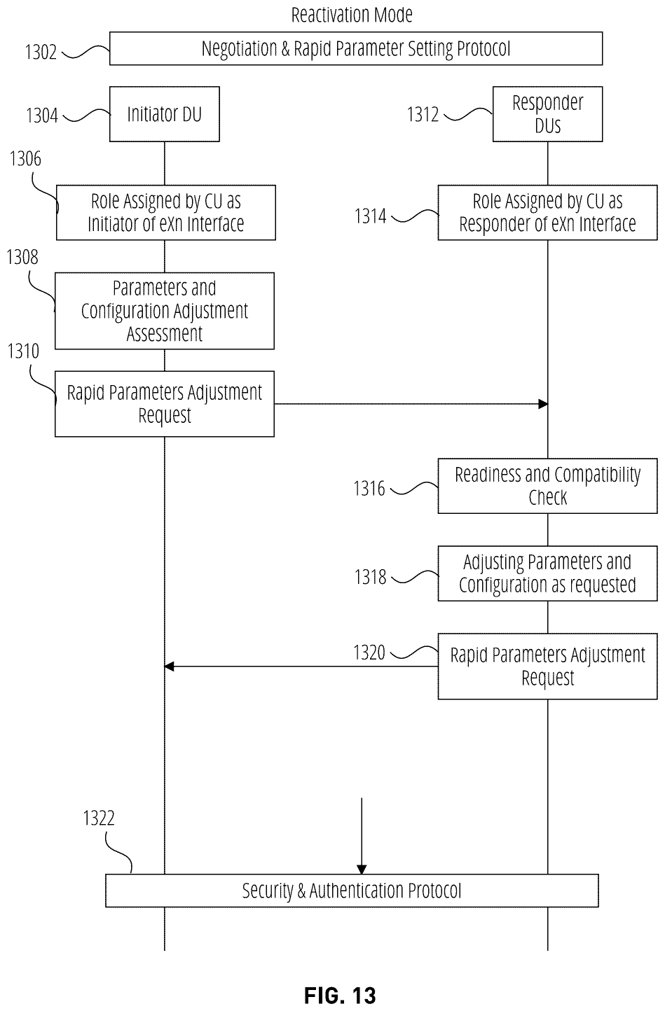

FIG. 13 illustrates an example of a negotiation and rapid parameter setting protocol 1302 according to a reactivation mode of an ISR, according to embodiments discussed herein. The initiator DU 1304 (the initiator air interface entity) is assigned 1306 a role by a CU (a cloud entity) as initiator of eXn interfaces with the responder DUs 1312 (responder air interface entities). The initiator DU 1304 assesses 1308 parameters and a configuration adjustment and transmits 1310 a corresponding rapid parameters adjustment request to responder DUs 1312 that have been assigned 1314 a role by the CU as responders of an eXn interface with the initiator DU 1304. The responder DUs 1312 check 1316 readiness and compatibility adjust 1318 parameters and configuration as requested by the initiator DU 1304. The responder DUs 1312 then transmit 1320 a rapid parameters adjustment request to the initiator DU 1304. The negotiation and rapid parameter setting protocol 1302 is followed by a security and authentication protocol 1322.

Embodiments for a security and authentication protocol (such as the security and authentication protocol 908) are now discussed.

In one embodiment, a security and authentication protocol may focus on establishing and maintaining a secure communication channel between DUs during the setup and/or reactivation of an eXn interface. The protocol may vary between an initialization mode and a reactivation modes of the ISR in a way that accommodates the different states of the eXn interface. It ensures that the communication on the eXn interface remains secure, whether being established anew or reactivated, by adapting its approach based on the current state of the eXn interface.

When the ISR is in the initialization mode, the objective of the security and authentication protocol is to establish a secure and trusted communication channel from scratch. A mutual authentication and key exchange negotiation is performed, where DUs engage in a mutual authentication process. This may involve protocols key exchange to securely negotiate encryption keys without transmitting them directly. A security parameter agreement is performed, where DUs agree upon the security protocols and parameters to be used e.g., the type of encryption to use, integrity protection methods to use, and/or data confidentiality measures to implement). Validation and confirmation is performed as a final check to ensure that all security parameters have been correctly set and acknowledged by all participating DUs.

When the ISR is in the reactivation mode, the objective of the security and authentication protocol is to quickly re-establish a secure communication channel using pre-established security parameters. A security context review is performed, where the initiator DU reviews a previously established security context and checks it for validity. Expedited re-authentication occurs if the previous security context is still valid, and an expedited re-authentication process is employed. A quick security parameter adjustment may be implemented, where quick adjustments to security parameters are made responsive changes in the network or security landscape. This might involve updating keys or changing encryption methods. A reaffirmation of security agreements is used to achieve a swift reaffirmation of security agreements to ensure proper integrity and confidentiality.

In some embodiments of the security and authentication protocol according to the initialization mode of an ISR, a mutual authentication request/response may be transmitted from all DUs to all DUs. The mutual authentication request/response may include a request ID that is a unique identifier for the initiation request. The mutual authentication request/response may include authentication credentials that are digital certificates or pre-shared keys for establishing trust. The mutual authentication request/response may include authentication requests and responses that are an exchange of authentication challenges and responses to verify each DU's identity. The mutual authentication request/response may include an authentication status that are indicators showing the success or failure of the mutual authentication process.

In some embodiments of the security and authentication protocol according to the initialization mode of an ISR, a key exchange negotiation request/response may be transmitted from all DUs to all DUs. The key exchange negotiation request/response may include a request ID that is a unique identifier for the initiation request. The key exchange negotiation request/response may include proposed security protocols that are suggestions for encryption and integrity protection methods. The key exchange negotiation request/response may include a security parameter negotiation that is a discussion and finalization of agreed-upon security parameters. The key exchange negotiation request/response may include key exchange acknowledgment that includes confirmation messages acknowledging successful key negotiations. The key exchange negotiation request/response may include a parameter confirmation from each DU indicating agreement on the security parameters.

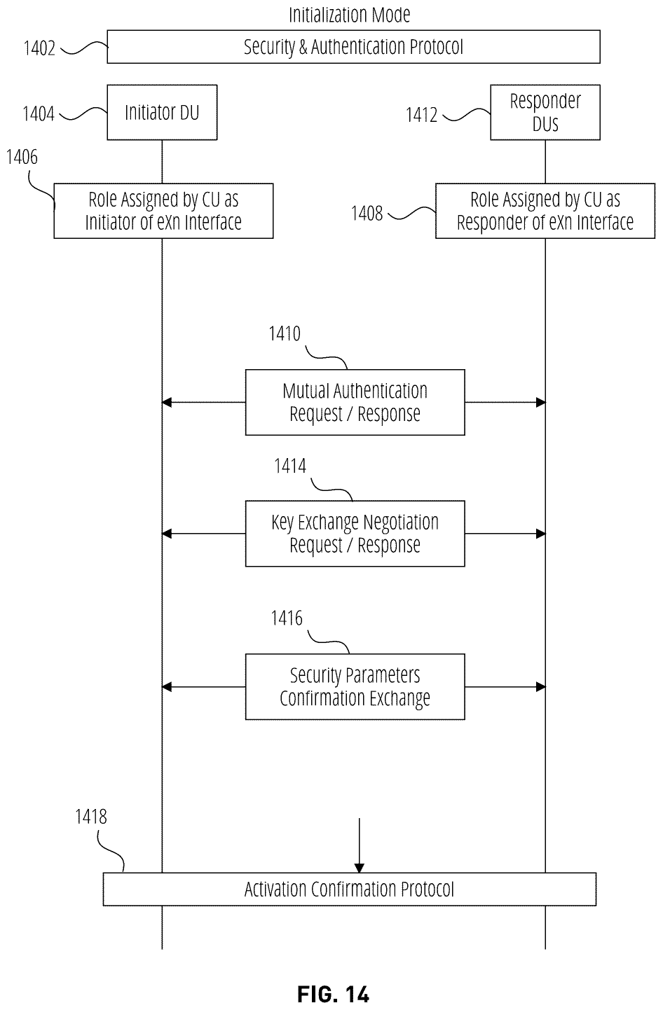

FIG. 14 illustrates an example of a security and authentication protocol 1402 according to an initialization mode of an ISR, according to embodiments discussed herein. The initiator DU 1404 (the initiator air interface entity) is assigned 1406 a role by a CU (a cloud entity) as initiator of cXn interfaces with the responder DUs 1412 (responder air interface entities). The responder DUs 1412 are assigned 1408 a role by the CU as responders of an eXn interface with the initiator DU 1404. All DUs transmit 1410 a mutual authentication request/response to all DUs. All DUs transmit 1414 a key exchange negotiation request/response to all DUs. All DUs transmit 1416 a security parameters confirmation exchange to all DUs. The security and authentication protocol 1402 is followed by an activation confirmation protocol 1418.

In some embodiments of the security and authentication protocol according to the reactivation mode of an ISR, a security context review request may be transmitted from the initiator DU to the responder DUs. The security context review request may include a DU ID that is a unique identifier of the initiator DU. The security context review request may include a request ID that is a unique identifier for the reactivation request. The security context review request may include a last active request ID that is a unique identifier of the latest activation/reactivation request to restore the previously-vetted security context linked. The security context review request may include a previous security context that includes details of the previously established security context, including encryption methods and keys. The security context review request may include a context validity check that is a request to confirm the validity of the previous security context.

In some embodiments of the security and authentication protocol according to the reactivation mode of the ISR, a security context restoration response may be transmitted from the responder DUs to the initiator DUs. The security context restoration response may include a DU ID that is a unique identifier of the responder ID. The security context restoration response may include a request ID that is a unique identifier for the reactivation request. The security context restoration response may include a last active request ID that is a unique identifier of the latest activation/reactivation request to restore the previously-vetted security context linked. The security context restoration response may include a response on validity that includes feedback from adjacent DUs on the continued security context relevance and validity and their compatibility readiness to resume operations under the existing security context.

In some embodiments of the security and authentication protocol according to the reactivation mode of an ISR, an expedited re-authentication request/response may be transmitted from all DUs to all DUs. The expedited re-authentication request/response may include a request ID that is a unique identifier of the initiation request. The expedited re-authentication request/response may include a re-authentication challenge that is a lighter-weight authentication challenge, utilizing pre-shared keys or credentials (e.g., security context). The expedited re-authentication request/response may include a re-authentication response that includes corresponding responses to the challenges to swiftly verify identity. The expedited re-authentication request/response may include a re-authentication status that includes indicators showing the success or failure of the expedited re-authentication process.

In some embodiments of the security and authentication protocol according to the reactivation mode of an ISR, a security context adjustment request/response may be transmitted from all DUs to all DUs. The security context adjustment request/response may include a request ID that is a unique identifier of the reactivation request. The security context adjustment request/response may include updated security parameters that include proposed changes to the security parameters, such as new encryption keys or methods. The security context adjustment request/response may include a parameter adjustment request/acknowledgment that requests for adjustments in security parameters and provides confirmations of such changes. The security context adjustment request/response may include a parameter update confirmation that arrives at a final agreement on the updated security parameters, ensuring alignment with current security requirements.

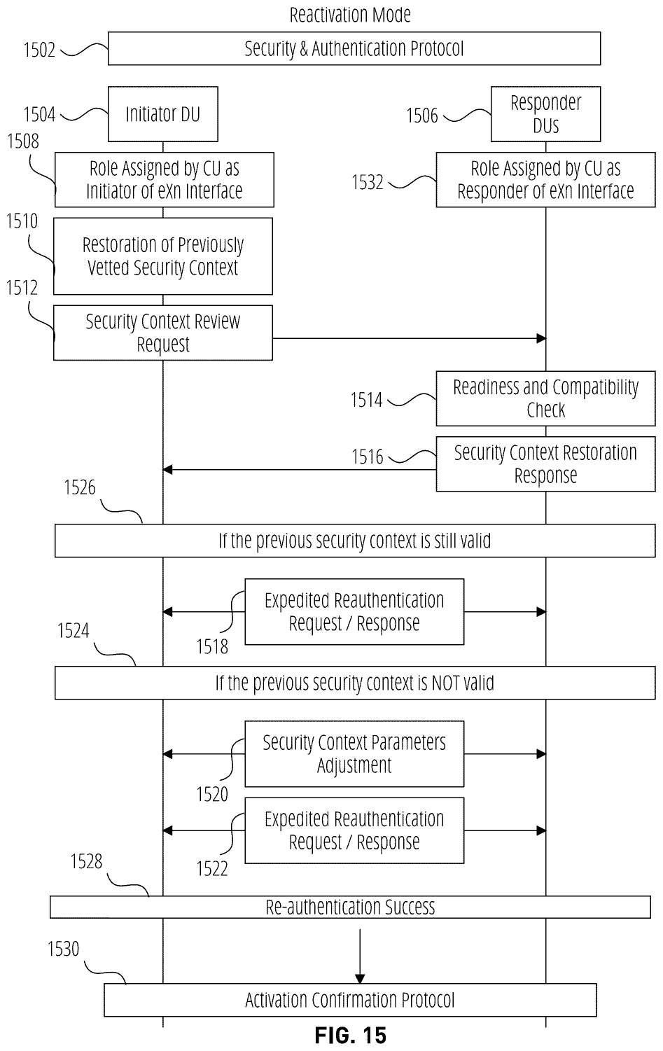

FIG. 15 illustrates an example of a security and authentication protocol 1502 according to a reactivation mode of an ISR, according to embodiments discussed herein. The initiator DU 1504 (the initiator air interface entity) is assigned 1508 a role by a CU (a cloud entity) as initiator of eXn interfaces with the responder DUs 1506 (responder air interface entities). The initiator DU 1504 restores 1510 a previously vetted security context and then transmits 1512 a security context review request to the responder DUs 1506. The responder DUs 1506 have been assigned 1532 a role by the CU as responders of an eXn interface with the initiator DU 1504. The responder DUs 1506 check 1514 readiness and compatibility and transmit 1516 a security context restoration response to the initiator DU 1504.

If the previous security context is still valid 1526, all DUs transmit 1518 an expedited reauthentication request/response to all DUs. If the previous security check is not valid 1524, all DUs transmit 1520 a security context parameters adjustment to all DUs. All DUs transmit 1522 an expedited reauthentication request/response to all DUs. Upon re-authentication success 1528, an activation confirmation protocol 1530 is executed.

Embodiments for an activation confirmation protocol 910 (such as the activation confirmation protocol 910) are now discussed.

An activation confirmation protocol of an ISR may encompass the final steps for setting up or reactivating an eXn interface. It ensures that the eXn interface, whether being initialized for the first time or reactivated, is fully functional and is ready for immediate operational use in the network.

When the ISR is in an initialization mode, the objective of the activation confirmation protocol is to formally confirm the eXn interface activation from an un-configured or INACTIVE state and confirm its operational readiness. A finalization of activation occurs using a final communication exchange between DUs, which confirms the successful activation of the interface.

When the ISR is in a reactivation mode, the objective of the activation confirmation protocol is to formally confirm the eXn interface reactivation to an operational state using previously retained configurations. A finalization of reactivation occurs using a final communication exchange between DUs, which confirms the successful reactivation of the interface.

In some embodiments of the activation confirmation protocol according to the initialization mode of an ISR, an activation confirmation command may be transmitted from the initiator DU to the responder DUs. The activation confirmation command may include a DU ID that is a unique identifier for the initiator DU. The activation confirmation command may include a request ID that is a unique identifier of the initiation request. The activation confirmation command may include an activation confirmation signal that is a signal from the initiator DU to all adjacent DUs to confirm the successful activation.

In some embodiments of the activation confirmation protocol according to the initialization mode, an activation acknowledgment command may be transmitted from the responder DUs to the initiator DU. The activation acknowledgment command may include a DU ID that is a unique identifier for the responder DU. The activation acknowledgment command may include a request ID that is a unique identifier of the initiation request. The activation acknowledgment command may include an acknowledgment of activation that includes responses from adjacent DUs acknowledging and agreeing to the confirmed operational status.

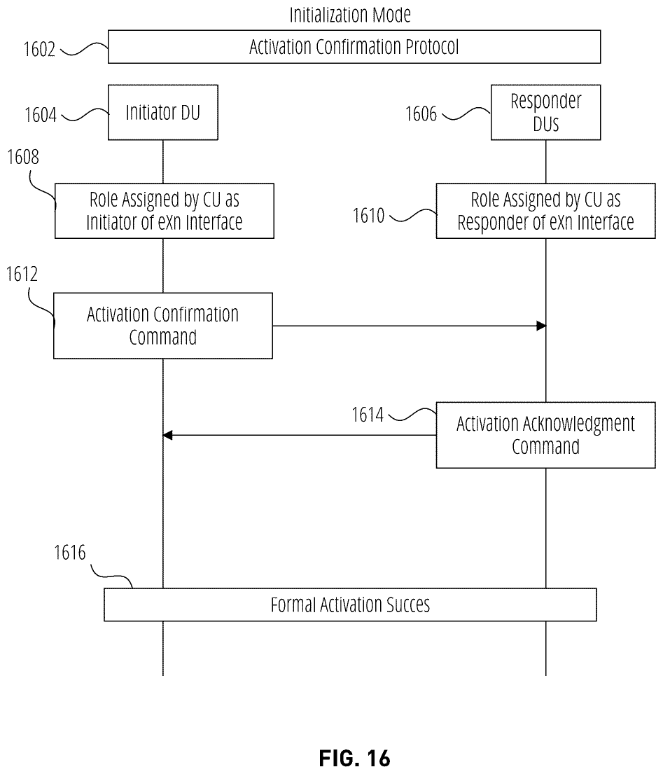

FIG. 16 illustrates an example activation confirmation protocol 1602 according to an initialization mode of an ISR, according to embodiments discussed herein. The initiator DU 1604 (the initiator air interface entity) is assigned 1608 a role by a CU (a cloud entity) as initiator of eXn interfaces with the responder DUs 1606 (responder air interface entities). The initiator DU 1604 transmits 1612 an activation confirmation command to the responder DUs 1606 that have been assigned 1610 a role by the CU as responders of an eXn interface with the initiator DU 1604. The responder DUs 1606 transmit 1614 an activation acknowledgment command to the initiator DU 1604. The activation confirmation protocol 1602 results in a formal activation success 1616.

In some embodiments of the activation confirmation protocol according to the reactivation mode of an ISR, a reactivation confirmation command may be transmitted from the initiator DU to the responder DUs. The reactivation confirmation command may include a DU ID that is a unique identifier for the initiator DU. The reactivation confirmation command may include a request ID that is a unique identifier of the initiation request. The reactivation confirmation command may include a reactivation confirmation signal that is a signal from the initiator DU to all adjacent DUs to confirm the successful reactivation.

In some embodiments of the activation confirmation protocol according to the reactivation mode of the ISR, a reactivation acknowledgement command may be transmitted from the responder DUs to the initiator DU. The reactivation acknowledgement command may include a DU ID that is a unique identifier of the responder DU. The reactivation acknowledgement command may include a request ID that is a unique identifier of the initiation request. The reactivation acknowledgement command may include an acknowledgment of reactivation that includes responses from adjacent DUs acknowledging and agreeing to the confirmed operational status.

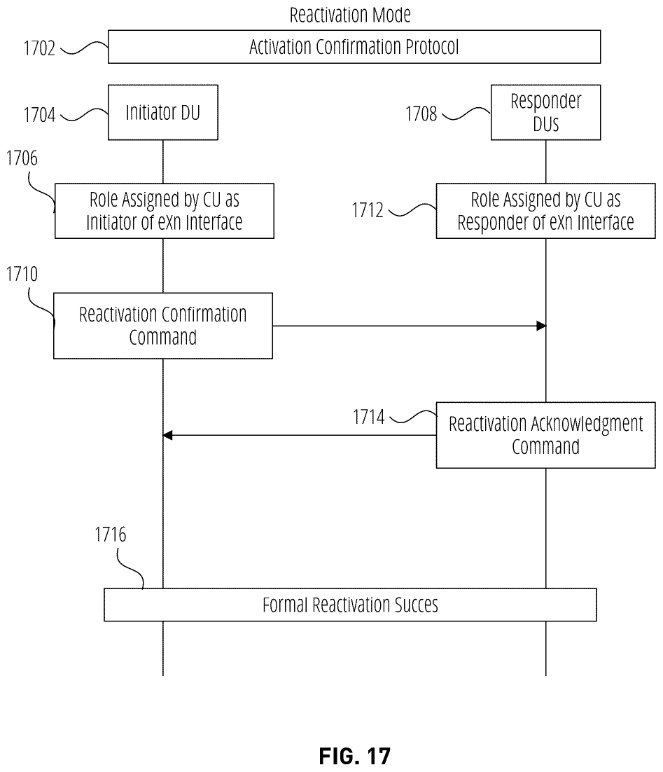

FIG. 17 illustrates an example activation confirmation protocol 1702 according to a reactivation mode, according to embodiments herein. The initiator DU 1704 (the initiator air interface entity) is assigned 1706 a role by a CU (a cloud entity) as initiator of eXn interfaces with the responder DUs 1708 (responder air interface entities). The initiator DU 1704 transmits 1710 a reactivation confirmation command to the responder DUs 1708 that have been assigned 1712 a role by the CU as responders of an eXn interface with the initiator DU 1704. The responder DUs 1708 transmit 1714 a reactivation acknowledgment command to the initiator DU 1704. The activation confirmation protocol 1702 results in a formal reactivation success 1716.

### Embodiments of IST Procedures

In some embodiments, an IST procedure is defined as a sequence of protocols that efficiently facilitates transitions of an eXn interface to a STANDBY state or to an ACTIVE state. The IST procedure adopts three operational modes: a termination mode, a hibernation mode and a standby deactivation mode.

A termination mode of an IST procedure may be used to formally deactivate an ACTIVE state eXn interface when it is no longer needed or if its performance degrades below acceptable thresholds. The termination mode may involve a series of steps to ensure a graceful shutdown of the eXn interface, including session transfers or closures, data preservation, de-authentication, and finally a final shutdown to transition the eXn interface to an INACTIVE state.

A hibernation mode of an IST procedure may be used to transition an eXn interface from an ACTIVE state into a low-activity, power-saving STANDBY state while maintaining readiness for quick reactivation. In the hibernation mode, operational activities of the eXn interface may be reduced significantly. However, essential configurations and parameters are retained to facilitate a quick return to an ACTIVE state when network demands resurge.

A standby deactivation mode of an IST procedure may be used to deactivate an eXn interface from a STANDBY state to an INACTIVE STATE, preparing it for a comprehensive re-initialization if network conditions need reactivation at a later time. This mode is similar to termination mode but adapted for the eXn interface's already reduced operational state. It involves formal deactivation steps, ensuring that the minimal activities and configurations maintained in the STANDBY state are appropriately shut down.

In some embodiments, the eXn IST procedure can adopt a sequence of four protocols that are used for each of the termination, hibernation, and standby deactivation modes. This sequence of four protocols may be used to ensure a fluid and efficient transition of the eXn interface across different operational states.

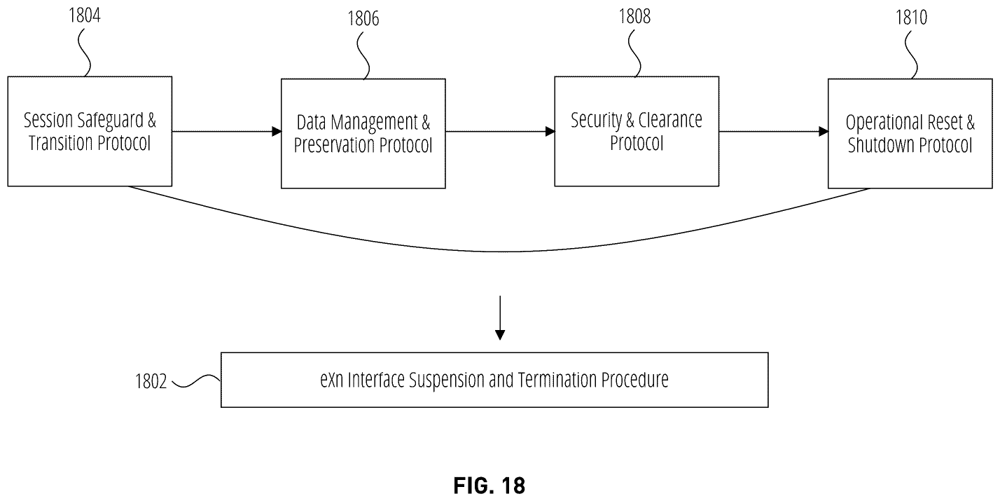

FIG. 18 illustrates an example eXn IST procedure 1802, according to embodiments discussed herein. The eXn IST procedure 1802 includes a session safeguard and transition protocol 1804, a data management and preservation protocol 1806, a security and clearance protocol 1808, and an operational reset and shutdown protocol 1810.

A session safeguard and transition protocol 1804 may be used to manage and secure active sessions, facilitating either their smooth transition or orderly closure during eXn interface changes.

A data management and preservation protocol 1806 may be used to ensure data integrity and prevent loss, by efficiently handling in-transit data during the suspension or termination of the eXn interface.

A security and clearance protocol 1808 may be used to maintain eXn interface security through de-authentication and clearing of shared security parameters during deactivation.

An operational reset and shutdown protocol 1810 may be defined to revert eXn interface settings to default or inactive states, concluding with a formal shutdown to mark the end of operational activity.

FIG. 18 illustrates an example eXn IST procedure 1802. A session safeguard and transition protocol 1804 is followed by a data management and preservation protocol 1806. The data management and preservation protocol 1806 is followed by a security and clearance protocol 1808, which is followed by an operational reset and shutdown protocol 1810.

Embodiments for a session safeguard and transition protocol (such as the session safeguard and transition protocol 1804) are now discussed.

A session safeguard and transition protocol may facilitate the secure management of sessions during eXn interface state transitions. In each mode of the IST, this protocol plays a role in safeguarding session continuity and data integrity, adapting its operations to suit the current eXn interface state and network demands.

When the IST is in a termination mode, one objective of the session safeguard and transition protocol is to ensure that active sessions are either securely transferred to another eXn interface or terminated in a controlled manner.

When the IST is in a hibernation mode, one objective of the session safeguard and transition protocol is to maintain session integrity while reducing the operational activities of the eXn interface.

When the IST is in the standby deactivation mode, one objective of the session safeguard and transition protocol is to deactivate any session from a STANDBY state while ensuring formal closure of any minimal activities of the eXn interface.

For all modes of the IST, the session safeguard and transition protocol may perform session analysis to assess all active sessions handled by the eXn interface for their status and requirements.

When the IST is in the termination mode, a transfer or closure decision may be taken by the session safeguard and transition protocol. The session safeguard and transition protocol decides whether to transfer sessions to another operational eXn interface or to close them gracefully, based on current network conditions and session priorities. The session safeguard and transition protocol proceeds to execute these decisions by implementing the chosen action, ensuring minimal disruption to ongoing services and data integrity.

When the IST is in the hibernation mode, minimized session activity may be instituted by the session safeguard and transition protocol. The session safeguard and transition protocol reduces session activity, aligning it with the reduced operational state of the eXn interface. The session safeguard and transition protocol applies session state preservation, marking active sessions for preservation, ensuring their state is maintained during the low-activity phase.

When the IST is in the standby deactivation mode, a final session clearance may be used by the session safeguard and transition protocol to ensure no residual session data or state remains that could impact network integrity upon reactivation.

In some embodiments of the session safeguard and transition protocol according to any mode of an IST procedure, a session status request may be transmitted from the initiator DU to the responder DUs. The session status request may include a DU ID that is a unique identifier for the initiator DU. The session status request may include a request ID that is a unique identifier of the termination request. The session status request may include an inquiry signal that is a request for information on all active sessions managed via eXn interface. The session status request may include a session detail request that is a specific request for details like session IDs, status, and priority.

In some embodiments of the session safeguard and transition protocol according to all modes of an IST procedure, a session status report may be transmitted from the responder DUs to the initiator DU. The session status report may include a DU ID that is a unique identifier for the responder DU. The session status report may include a request ID that is a unique identifier of the termination request. The session status report may include an acknowledgment of session status inquiry signal that is a confirmation that the session status signal was received. The session status report may include requested session details that are requested details of each active session, details like session IDs, status, and priority.

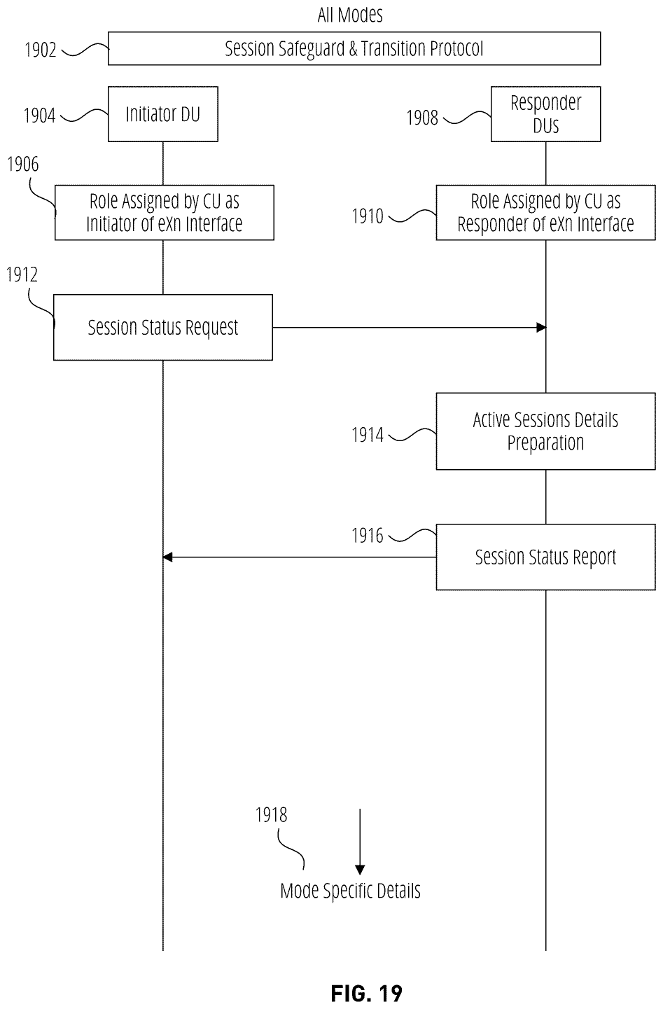

FIG. 19 illustrates an example of a session safeguard and transition protocol 1902 according to all modes of an IST procedure, according to embodiments discussed herein. The initiator DU 1904 (the initiator air interface entity) is assigned 1906 a role by a CU (a cloud entity) as initiator of eXn interfaces with the responder DUs 1908 (responder air interface entities). The initiator DU 1904 transmits 1912 a session status request to the responder DUs 1908 that have been assigned 1910 a role by the CU as responders of an eXn interface with the initiator DU 1904 The responder DUs 1908 prepare 1914 active sessions details. The responder DUs 1908 transmit 1916 a corresponding session status report to the initiator DU 1904. The session safeguard and transition protocol 1902 for all modes is followed by mode specific details 1918 (to be discussed).

In some embodiments of the session safeguard and transition protocol according to the termination mode and/or a standby deactivation mode of an ISR, a session handling command may be transmitted from the initiator DU to the responder DUs. The session handling command may include a DU ID that is a unique identifier for the initiator DU. The session handling command may include a request ID that is a unique identifier of the termination request. The session handling command may include an operational termination request that includes specific instructions for each active session, including destination eXn interface for transfers or closure procedures. The session handling command may include a session state termination request that includes specific instructions for each session to ensure their current state is deleted before termination.

In some embodiments of the session safeguard and transition protocol according to the termination mode and/or the standby deactivation mode of an ISR, a session safeguard action execution may be transmitted from all DUs to all DUs. The session safeguard action execution may include a session ID that is a unique identifier of each session. The session safeguard action execution may include a request ID that is a unique identifier of the termination request. The session safeguard action execution may include an acknowledgment of session status that is a status confirmation on the implementation status of the transfer or closure decision.

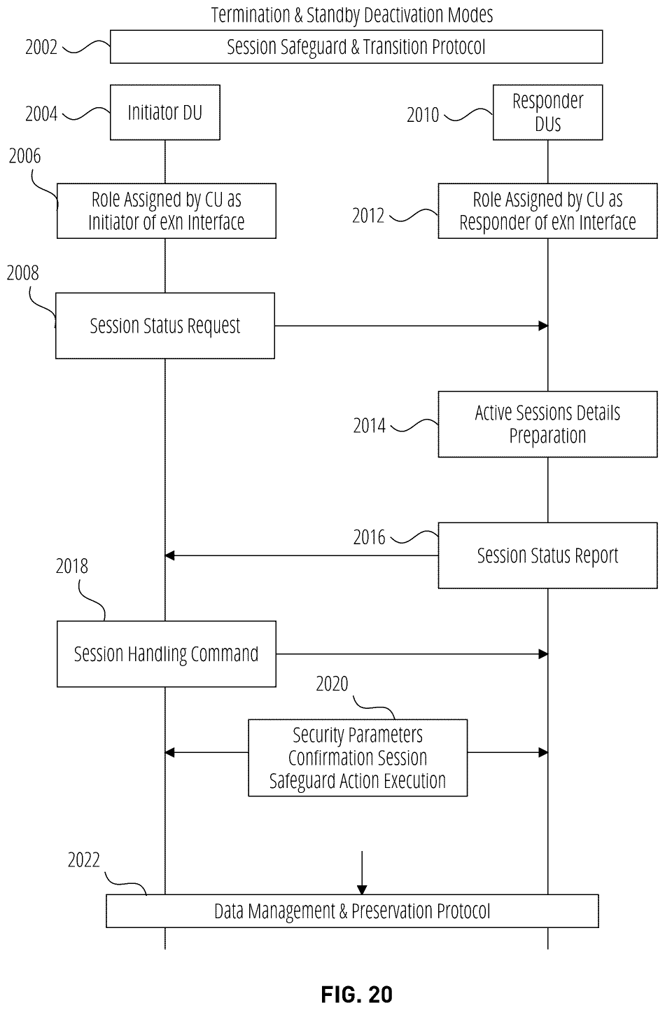

FIG. 20 illustrates an example of a session safeguard and transition protocol 2002 according to termination mode and/or a standby deactivation mode of an IST procedure, according to embodiments discussed herein. The initiator DU 2004 (the initiator air interface entity) is assigned 2006 a role by a CU (a cloud entity) as initiator of eXn interfaces with the responder DUs 2010 (responder air interface entities). The initiator DU 2004 transmits 2008 a session status request to the responder DUs 2010, which have been assigned 2012 a role by the CU as responders of an eXn interface with the initiator DU 2004. The responder DUs 2010 prepare 2014 active sessions details and transmit 2016 a session status report to the initiator DU 2004. The initiator DU 2004 transmits 2018 a session handling command to the responder DUs 2010. All DUs transmit 2020 a session safeguard action execution to all DUs. The session safeguard and transition protocol 2002 for termination and standby deactivation modes is followed by data management and preservation protocol 2022.

In some embodiments of the session safeguard and transition protocol according to the hibernation mode of an IST, a session handling command may be transmitted from the initiator DU to the responder DUs. The session handling command may include a DU ID that is a unique identifier for the initiator DU. The session handling command may include a request ID that is a unique identifier of the termination request. The session handling command may include a session ID that is a unique identifier of each session. The session handling command may include an operational hibernation request that includes specific instructions for each session, outlining the extent and nature of the reduced data handling activities for each active session. The session handling command may include a session state preservation request that includes specific instructions for maintaining the session state of essential data processes for quick resumption.

In some embodiments of the session safeguard and transition protocol according to the hibernation mode of an IST, a session safeguard action execution may be transmitted from all DUs to all DUs. The session safeguard action execution may include a session ID that is a unique identifier the responder DU. The session safeguard action execution may include a request ID that is a unique identifier of the termination request. The session safeguard action execution may include an acknowledgment of session status that is a status confirmation of the session state preservation request, ensuring reduced data handling activities for each active session.

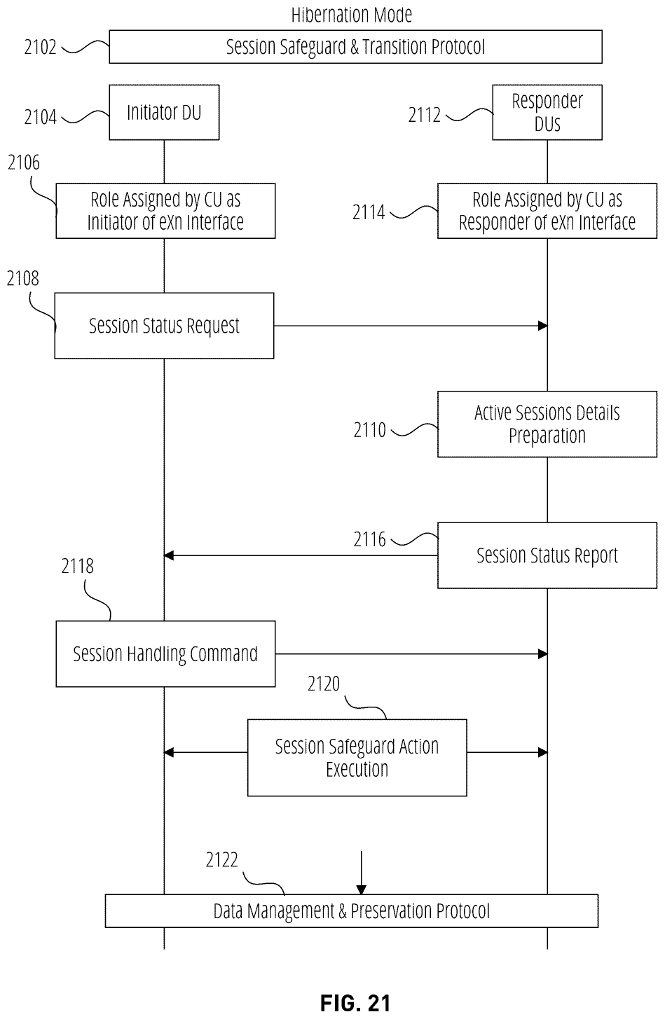

FIG. 21 illustrates an example of a session safeguard and transition protocol 2102 according to a hibernation mode of an IST procedure, according to embodiments discussed herein. The initiator DU 2104 (the initiator air interface entity) is assigned 2106 a role by a CU (a cloud entity) as initiator of eXn interfaces with the responder DUs 2112 (responder air interface entities). The initiator DU 2104 transmits 2108 a session status request to the responder DUs 2112 that have been assigned 2114 a role by the CU as a responder of an eXn interface with the initiator DU 2104. The responder DUs 2112 prepare 2110 active sessions details and transmit 2116 a session status report to the initiator DU 2104. The initiator DU 2104 transmits 2118 a session handling command to the responder DUs 2112. All DUs transmit 2120 a session safeguard action execution to all DUs. The session safeguard and transition protocol 2102 is followed by a data management and preservation protocol 2122.

Embodiments for a data management and preservation protocol (such as the data management and preservation protocol 1806) are now discussed.

A data management and preservation protocol within an IST procedure framework is helpful for handling data during transitions between operational states of the eXn interface. It ensures that data management adapts to the varying levels of interface activity, prioritizing data integrity and continuity across all states of the eXn interface.

When the IST is in the termination mode, one objective of the data management and preservation protocol is to manage and safeguard in-transit and buffered data during the eXn interface deactivation process.

When the IST is in the hibernation mode, one objective of the data management and preservation protocol is to is to minimize data processing activities while maintaining data integrity during the eXn interface's low-activity state.

When the IST is in the standby deactivation mode, one objective of the data management and preservation protocol is to is to handle and finalize any residual data activities as the eXn interface transitions from a standby to an INACTIVE state.

When the IST is in any mode, the data management and preservation protocol may use a data integrity assessment that evaluates the status of data currently being processed or queued in the eXn interface to determine needed actions. Using a data flushing or preservation mechanism, a data management and preservation protocol can initiate procedures to either flush out pending data transmissions to their destination or to store them securely for future processing in the case of any needed data processes that need to be quickly resumed upon reactivation.

In some embodiments of the data management and preservation protocol according to all modes of an IST procedure, a data buffer status request may be transmitted from the initiator DU to the responder DUs. The data buffer status request may include a DU ID that is a unique identifier for the initiator DU. The data buffer status request may include a request ID that is a unique identifier of the termination request. The data buffer status request may include inquiry signal that is a request for information on the data buffers of all active sessions managed via eXn interface. The data buffer status request may include a session detail request that is a specific request for details like session IDs, status, and/or priority.

In some embodiments of the data management and preservation protocol according to all modes of an IST procedure, a data buffer status report may be transmitted from the responder DUs to the initiator DU. The data buffer status report may include a DU ID that is a unique identifier for the responder DU. The data buffer status report may include a request ID that is a unique identifier of the termination request. The data buffer status report may include requested data buffer details that include requested data buffer details of each active session, such as session IDs, status, and/or priority.

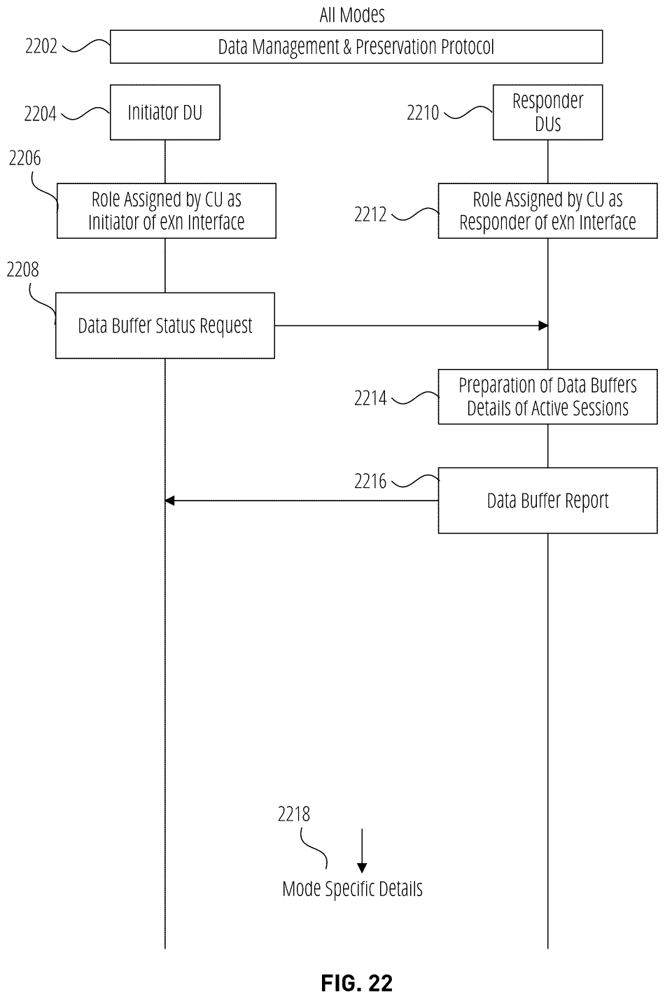

FIG. 22 illustrates an example data management and preservation protocol 2202 according to all modes of an IST procedure, according to embodiments discussed herein. The initiator DU 2204 (the initiator air interface entity) is assigned 2206 a role by a CU (a cloud entity) as initiator of eXn interfaces with the responder DUs 2210 (responder air interface entities). The initiator DU 2204 transmits 2208 a data buffer status request to the responder DUs 2210 that have been assigned 2212 a role by the CU as responders of an eXn interface with the initiator DU 2204. The responder DUs 2210 prepare 2214 data buffers details of active sessions and transmit 2216 a data buffer report to the 2204. The data management and preservation protocol 2202 is followed by mode specific details 2218.

In some embodiments of the data management and preservation protocol according to all modes of an IST procedure, a data buffer handling command may be transmitted from the initiator DU to the responder DUs. The data buffer handling command may include a DU ID that is a unique identifier for the initiator DU. The data buffer handling command may include a request ID that is a unique identifier of the termination request. The data buffer handling command may include a session ID that is a unique identifier of each active session. The data buffer handling command may include a data handling request that includes specific instructions for each data buffer of each active session, including either flushing out pending data transmissions to their destination or to storing them securely for future processing. The data buffer handling command may include data handling instructions that include specific directions for safely transmitting pending data to its intended destination or securely storing data that cannot be transmitted immediately.

In some embodiments of the data management and preservation protocol according to all modes of an IST procedure, a data preservation action execution may be transmitted from all DUs to all DUs. The data preservation action execution may include a session ID that is a unique identifier of each session. The data preservation action execution may include a request ID that is a unique identifier of the termination request. The data buffer action execution may include an acknowledgment of status that includes, for each session, status confirmation on the implementation of proper data preservation protocol by either flushing out pending data transmissions to their destination or storing them securely for future processing.

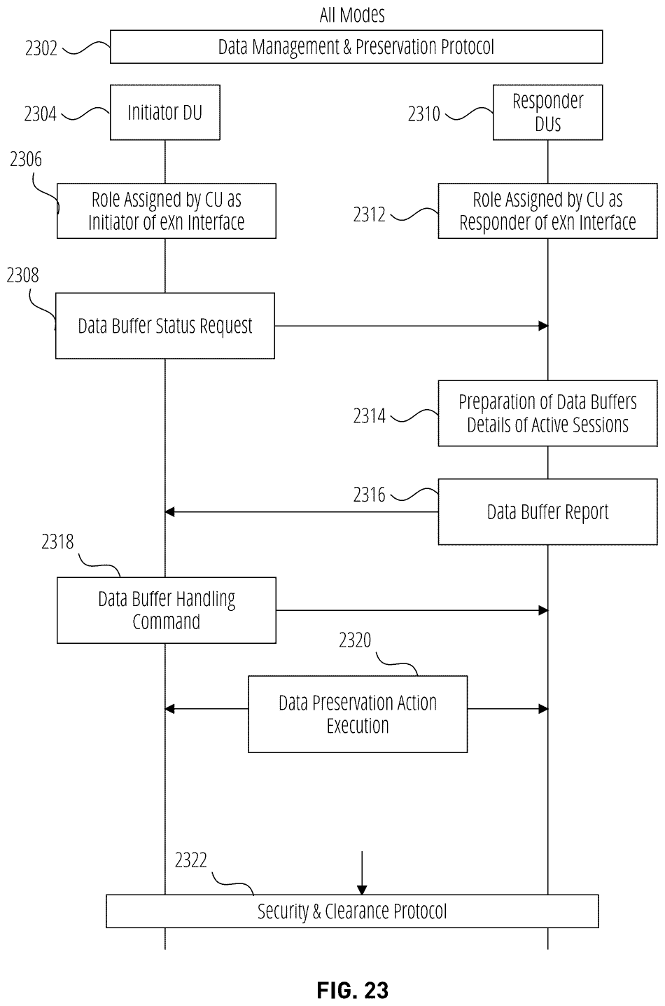

FIG. 23 illustrates another example data management and preservation protocol 2302 according to all modes of an IST procedure, according to embodiments discussed herein. The initiator DU 2304 (the initiator air interface entity) is assigned 2306 a role by a CU (a cloud entity) as initiator of eXn interfaces with the responder DUs 2310 (responder air interface entities). The initiator DU 2304 transmits 2308 a data buffer status request to the responder DUs 2310 that have been assigned 2312 a role by the CU as responders of an eXn interface with the initiator DU 2304. The responder DUs 2310 prepare 2314 data buffers details of active sessions and transmit 2316 a data buffer report to the initiator DU 2304. The initiator DU 2304 transmits 2318 a data buffer handling command to the responder DUs 2310. All DUs transmit 2320 a data preservation action execution to all DUs. The data management and preservation protocol 2302 is followed by a security and clearance protocol 2322.

Embodiments for a security and clearance protocol (such as the security and clearance protocol 1808) are now discussed.

A security and clearance protocol is an aspect of the IST procedure that focuses on maintaining secure operations and proper clearance during state transitions of the eXn interface. It prioritizes network security and data protection, adapting to different operational states to ensure the eXn interface remains secure and ready for any state transitions.

When the IST is in a termination mode, one objective of the security and clearance protocol is to securely terminate the eXn interface while ensuring the confidentiality and integrity of the network.

When the IST is in a hibernation mode, one objective of the security and clearance protocol is to maintain essential security parameters in a reduced operational state, ensuring quick and secure reactivation.

When the IST is in a standby deactivation mode, one objective of the security and clearance protocol is to transition from standby to an INACTIVE state while maintaining security standards.

For all possible modes of an IST procedure, a security and clearance protocol may implement a security status evaluation that includes reviewing current security settings and ongoing secure communications to prepare for termination.

When the IST is in a termination mode or a standby deactivation mode, The security and clearance protocol uses mutual de-authentication, implementing procedures for secure disconnection and for ensuring that all connected DUs mutually authenticate the termination process. Further, the security and clearance protocol provides for erasure of security parameters, including securely erasing all shared security keys and sensitive information to prevent unauthorized access.

When the IST is in a hibernation mode, the security and clearance protocol implements a partial security preservation mechanism that may include retaining core security configurations to enable quick reactivation while minimizing active security operations.

In some embodiments of the security and clearance protocol according to all modes of an IST procedure, a security context status request may be transmitted from the initiator DU to the responder DUs. The security context status request may include a DU ID that is a unique identifier for the initiator DU. The security context status request may include a request ID that is a unique identifier of the termination request. The security context status request may include an inquiry signal that includes a request for security context information of all active sessions managed via eXn interface. The security context status request may include a session detail request that is a specific request for details like session IDs, status, and/or priority.

In some embodiments of the security and clearance protocol according to all modes of an IST procedure, a security context status response may be transmitted from the responder DUs to the initiator DU. The security context status response may include a DU ID that is a unique identifier of the responder DU. The security context status response may include a request ID that is a unique identifier of the termination request. The security context status response may include a requested security context details that include requested security context details of each active session associated with details like session IDs, status, and/or priority.

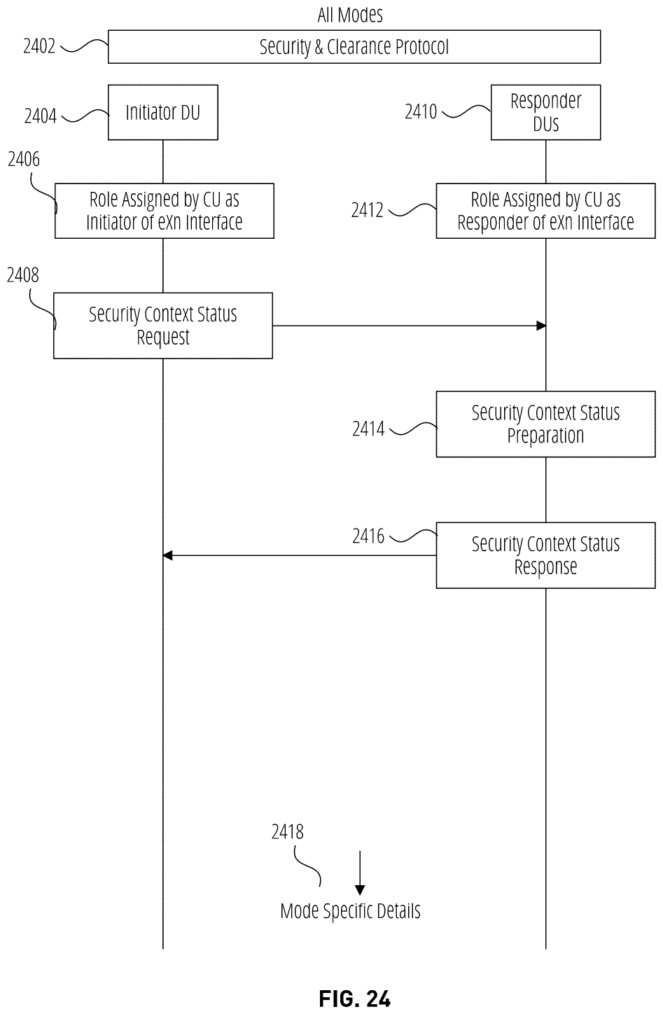

FIG. 24 illustrates an example of a security and clearance protocol 2402 according to all modes of an IST procedure, according to embodiments discussed herein. The initiator DU 2404 (the initiator air interface entity) is assigned 2406 a role by a CU (a cloud entity) as initiator of eXn interfaces with the responder DUs 2410 (responder air interface entities). The initiator DU 2404 transmits 2408 a security context status request to the responder DUs 2410 that have been assigned 2412 a role by the CU as responders of an eXn interface with the initiator DU 2404. The responder DUs 2410 prepare 2414 a security context status and transmit 2416 a security context status response to the initiator DU 2404. The security and clearance protocol 2402 is followed by mode specific details 2418.

In some embodiments of the security and clearance protocol according to a termination mode and/or a standby deactivation mode of an IST, a full mutual de-authentication request/response may be transmitted from all DUs to all DUs. The full mutual de-authentication request/response may include a request ID that is a unique identifier of the termination request. The full mutual de-authentication request/response may include full de-authentication requests and responses that exchange methodology of the full de-authentication process, ensuring fully secure disconnection. The full mutual de-authentication request/response may include an authentication status that includes a confirmation from each DU to verify full mutual de-authentication and validate the integrity of the process.

In some embodiments of the security and clearance protocol according to the termination and/or standby deactivation modes, a security context clearance command may be transmitted from all DUs to all DUs. The security context clearance command may include a request ID that is a unique identifier of the termination request. The security context clearance command may include security context erasure requests and responses that exchange methodology and instructions for securely erasing all shared security context, keys and sensitive data. The security context clearance command may include a security context clearance status that includes a confirmation from each DU to confirm the successful erasure of security parameters.

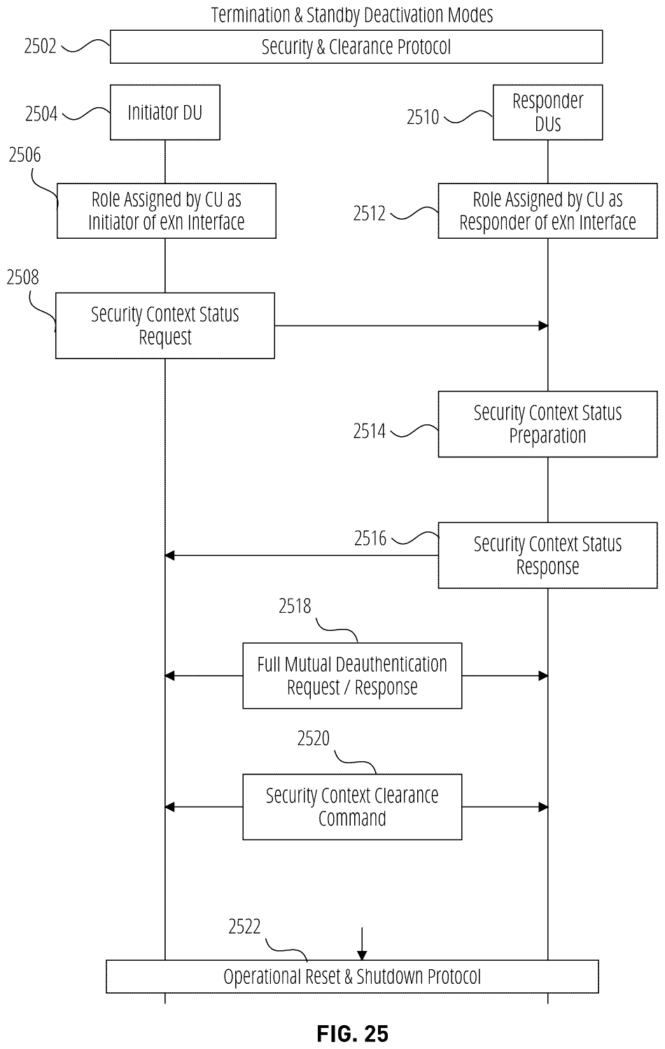

FIG. 25 illustrates an example of a security clearance and protocol 2502 according to termination mode and/or a standby deactivation mode of an IST, according to embodiments discussed herein. The initiator DU 2504 (the initiator air interface entity) is assigned 2506 a role by the CU as initiator of eXn interfaces with the responder DUs 2510 (responder air interface entities). The initiator DU 2504 transmits 2508 a security context status request to the responder DUs 2510 that have been assigned 2512 by a CU (a cloud entity) as responders of eXn interfaces with the initiator DU 2504. The responder DUs 2510 prepare 2514 a security context status and transmit 2516 a security context status response to the initiator DU 2504. All DUs transmit 2518 a full mutual de-authentication request/response to all DUs. All DUs transmit 2520 a security context clearance command to all DUs. The security clearance and protocol 2502 is followed by an operational reset and shutdown protocol 2522.

In some embodiments of the security and clearance protocol according to the hibernation mode of the IST, a partial mutual de-authentication request/response may be transmitted from all DUs to all DUs. The partial mutual de-authentication request/response may include a request ID that is a unique identifier of the termination request. The partial mutual de-authentication request/response may include partial de-authentication requests and responses that exchange methodology of the partial de-authentication process, ensuring secure reduced data handling activities. The partial mutual de-authentication request/response may include an authentication status that includes a confirmation from each DU to verify partial mutual de-authentication and validate the integrity of the process.

In some embodiments of the security and clearance protocol according to the hibernation mode, a security context preservation command may be transmitted from all DUs to all DUs. The security context preservation command may include a request ID that is a unique identifier of the termination request. The security context preservation command may include security context preservation requests that include instructions for securely preserving all shared security context, keys and sensitive data. The security context preservation command may include a security context preservation status that includes a confirmation from each DU to confirm the successful preservation of security parameters.

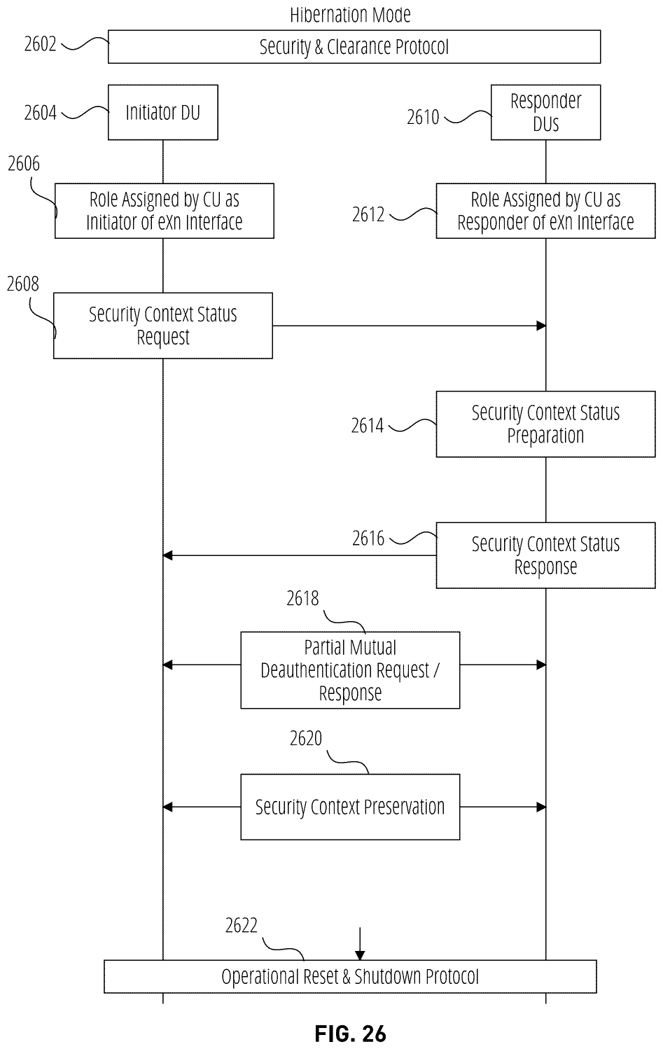

FIG. 26 illustrates an example of a security and clearance protocol 2602 according to a hibernation mode of an IST, according to embodiments discussed herein. The initiator DU 2604 (the initiator air interface entity) is assigned 2606 a role by a CU (a cloud entity) as initiator of eXn interfaces with the responder DUs 2610 (responder air interface entities). The initiator DU 2604 transmits 2608 a security context status request to the responder DUs 2610 that have been assigned 2612 a role by the CU as responders of eXn interfaces with the initiator DU 2604. The responder DUs 2610 prepare 2614 a security context status and transmit 2616 a security context status response to the initiator DU 2604. All DUs transmit 2618 a partial mutual de-authentication request/response to all DUs. All DUs transmit 2620 a security context preservation to all DUs. The security and clearance protocol 2602 is followed by an operational reset and shutdown protocol 2622.

Embodiments for an operational reset and shutdown protocol 1810 (such as the operational reset and shutdown protocol 1810) are now discussed.

An operational reset and shutdown protocol is a component of the IST procedure that manages the final steps of transitioning the eXn interface to different states, focusing on the formal termination or suspension of the eXn interface.

When the IST is in a termination mode, one objective of the operational reset and shutdown protocol is to properly shut down the eXn interface, ensuring an orderly and efficient transition to an INACTIVE state.

When the IST is in a hibernation mode, one objective of the operational reset and shutdown protocol is to properly suspend the eXn interface to the STANDBY state, preserving essential settings for quick reactivation.

When the IST is in a standby deactivation mode, one objective of the operational reset and shutdown protocol is to deactivate the eXn interface from a STANDBY state, preparing for comprehensive re-initialization.

In all modes of an IST procedure, a complete shutdown of suspension process utilized by the operational reset and shutdown protocol executes a full shutdown or suspension process, ready for future re-initialization or quick re-activation. A parameter reset or preservation may be implemented by an operational reset and shutdown protocol, in which all operational parameters and configurations specific to an eXn interface are reset or preserved.

In some embodiments of the operational reset and shutdown protocol according to all modes of an IST, a shutdown confirmation command may be transmitted from the initiator DU to the responder DUs. The shutdown confirmation command may include a DU ID that is a unique identifier of the initiator DU. The shutdown confirmation command may include a request ID that is a unique identifier of the termination request. The shutdown confirmation command may include a termination or suspension confirmation signal that is a signal from the initiator DU to all adjacent DUs to confirm the successful eXn interface termination or suspension. The shutdown confirmation command may include reset or preservation instructions that include specific steps and actions possibly needed to preserve or clear and reset parameters and configurations maintained during the operational state.

In some embodiments of the operational reset and shutdown protocol according to all modes, a shutdown acknowledgment command may be transmitted from the responder DUs to the initiator DU. The shutdown confirmation command may include a DU ID that is a unique identifier of the responder DU. The shutdown acknowledgment command may include a request ID that is a unique identifier of the termination request. The shutdown acknowledgment command may include an acknowledgment of termination or suspension that includes responses from adjacent DUs acknowledging and agreeing to the eXn interface termination or suspension signal. The shutdown acknowledgment command may include an acknowledgment of reset or preservation request that includes responses from adjacent DUs acknowledging resetting parameters and configurations maintained during the operational state.

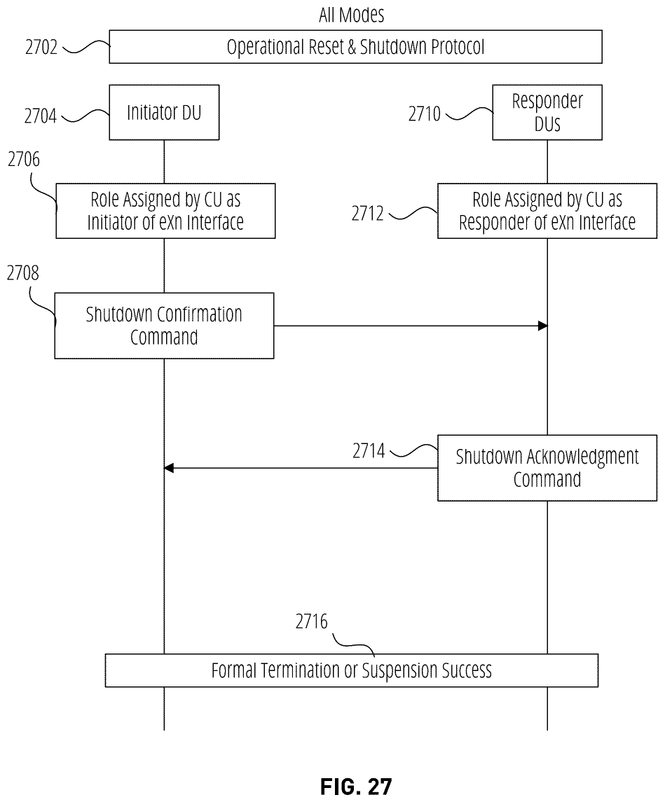

FIG. 27 illustrates an example of an operational reset and shutdown protocol 2702 according to all modes of an IST procedure, according to embodiments discussed herein. The initiator DU 2704 (the initiator air interface entity) is assigned 2706 a role by a CU (a cloud entity) as initiator of eXn interfaces with the responder DUs 2710 (responder air interface entities). The initiator DU 2704 transmits 2708 a shutdown confirmation command to the responder DUs 2710 that have been assigned 2712 a role by the CU as responders of eXn interfaces with the initiator DU 2704. The responder DUs 2710 transmit 2714 a shutdown acknowledgment command to the initiator DU 2704. The operational reset and shutdown protocol 2702 results in a formal termination or suspension success 2716.

### Additional Example Embodiments

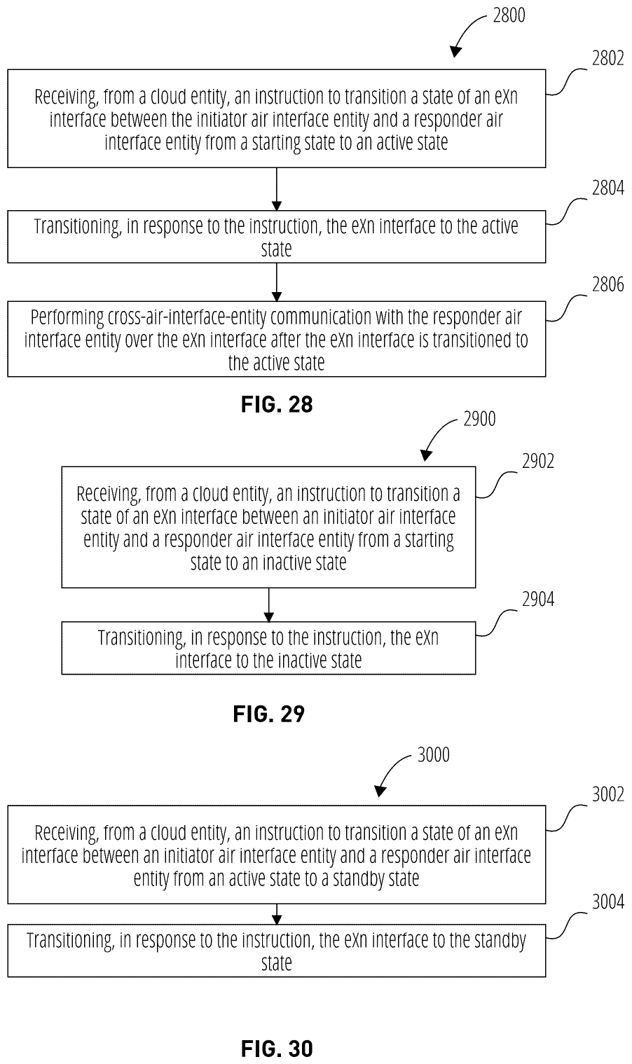

FIG. 28 illustrates a method 2800 of an initiator air interface entity of a cell-free network using dynamic associations of air interface entities and cloud entities, according to embodiments discussed herein. The method 2800 includes receiving 2802, from a cloud entity, an instruction to transition a state of an eXn interface between the initiator air interface entity and a responder air interface entity from a starting state to an active state. The method 2800 includes transitioning 2804, in response to the instruction, the eXn interface to the active state. The method 2800 includes performing 2806 cross-air-interface-entity communication with the responder air interface entity over the eXn interface after the eXn interface is transitioned to the active state.

In some embodiments of the method 2800, the starting state comprises an inactive state. In some of these embodiments, the transitioning 2804 comprises broadcasting a discovery signal; and receiving, from the responder air interface entity, in response to the discovery signal, a discovery signal response that identifies the responder air interface entity to the initiator air interface entity. In some of these embodiments, the transitioning 2804 comprises sending, to the responder air interface entity, a parameter proposal for a parameter that defines the eXn interface; and receiving, from the responder air interface entity, in response to the parameter proposal, an approval of the parameter proposal. In some of these embodiments, the transitioning 2804 comprises performing a security key exchange with the responder air interface entity.

In some embodiments of the method 2800, the starting state comprises a standby state. In some of these embodiments, the transitioning 2804 comprises broadcasting a reactivation signal comprising a stored eXn configuration; and receiving, from the responder air interface entity, in response to the reactivation signal, a reactivation signal acknowledgement that indicates that the responder air interface entity is ready to use the stored eXn configuration for the eXn interface. In some of these embodiments, the transitioning 2804 comprises determining, based on a current network condition, an updated parameter for a stored eXn configuration; sending, to the responder air interface entity, the updated parameter for the stored eXn configuration; and receiving, from the responder air interface entity, in response to the updated parameter, a parameter update acknowledgment indicating that the responder air interface entity is ready to use the updated parameter for the eXn interface. In some of these embodiments, the transitioning 2804 comprises sending, to the responder air interface entity, security context information for a previous security context between the initiator air interface entity and the responder air interface entity; and receiving, from the responder air interface entity, in response to the security context information for the previous security context, an indication that the responder air entity is ready to use the previous security context.

FIG. 29 illustrates a method 2900 of an initiator air interface entity of a cell-free network using dynamic associations of air interface entities and cloud entities, according to embodiments discussed herein. The method 2900 includes receiving 2902, from a cloud entity, an instruction to transition a state of an eXn interface between an initiator air interface entity and a responder air interface entity from a starting state to an inactive state. The method 2900 includes transitioning 2904, in response to the instruction, the cXn interface to the inactive state.

In some embodiments of the 2900, the starting state comprises an active state.

In some embodiments of the 2900, the starting state comprises a standby state.

In some embodiments of the 2900, the transitioning 2904 comprises sending, to the responder air interface entity, a session handling message indicating a destination interface for a current session on the eXn interface; and receiving, from the responder air interface entity, a destination interface acknowledgment indicating that the current session has been transferred to the destination interface.

In some embodiments of the 2900, the transitioning 2904 comprises sending, to the responder air interface entity, data handling instructions indicating an intended destination of pending data of a current session on the eXn interface; and receiving, from the responder air interface entity, in response to the data handling instructions, a data handling acknowledgement indicating that the pending data has been flushed to the intended destination.

In some embodiments of the method 2900, the transitioning 2904 comprises sending, to the responder air interface entity, a de-authentication request instructing the responder air interface entity to release a security context between the initiator air interface entity and the responder air interface entity; and receiving, from the responder air interface entity, in response to the de-authentication request, a de-authentication acknowledgement indicating that the responder air interface entity has released the security context.

FIG. 30 illustrates a method 3000 of an initiator air interface entity of a cell-free network using dynamic associations of air interface entities and cloud entities, according to embodiments discussed herein. The method 3000 includes receiving 3002, from a cloud entity, an instruction to transition a state of an eXn interface between an initiator air interface entity and a responder air interface entity from an active state to a standby state. The method 3000 includes transitioning 3004, in response to the instruction, the cXn interface to the standby state.

In some embodiments of the method 3000, the transitioning 3004 comprises sending, to the responder air interface entity, a session handing message comprising instructions for maintaining a session state for a current session on the eXn interface; and receiving, from the responder air interface entity, a session handing acknowledgement indicating that the current session will be maintained on the eXn interface.

In some embodiments of the method 3000, the initiator DU 2004 includes sending, to the responder air interface entity, a partial de-authentication request instructing the responder air interface entity to partially release a security context between the initiator air interface entity and the responder air interface entity; and s receiving, from the responder air interface entity, in response to the de-authentication request, a partial de-authentication acknowledgement indicating that the responder air interface entity has partially released the security context.

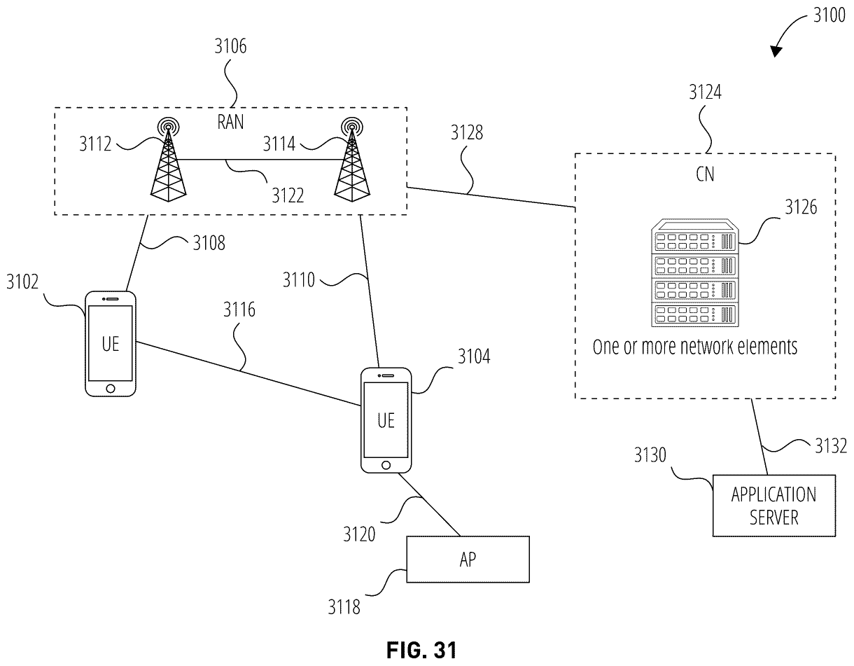

FIG. 31 illustrates an example architecture of a wireless communication system 3100, according to embodiments disclosed herein. The following description is provided for an example wireless communication system 3100 that operates in conjunction with the LTE system standards and/or 5G or NR system standards as provided by 3GPP technical specifications.

As shown by FIG. 31, the wireless communication system 3100 includes UE 3102 and UE 3104 (although any number of UEs may be used). In this example, the UE 3102 and the UE 3104 are illustrated as smartphones (e.g., handheld touchscreen mobile computing devices connectable to one or more cellular networks), but may also comprise any mobile or non-mobile computing device configured for wireless communication.

The UE 3102 and UE 3104 may be configured to communicatively couple with a RAN 3106. In embodiments, the RAN 3106 may be NG-RAN, E-UTRAN, etc. The UE 3102 and UE 3104 utilize connections (or channels) (shown as connection 3108 and connection 3110, respectively) with the RAN 3106, each of which comprises a physical communications interface. The RAN 3106 can include one or more base stations (such as base station 3112 and base station 3114) that enable the connection 3108 and connection 3110.

In this example, the connection 3108 and connection 3110 are air interfaces to enable such communicative coupling, and may be consistent with RAT(s) used by the RAN 3106, such as, for example, an LTE and/or NR.

In some embodiments, the UE 3102 and UE 3104 may also directly exchange communication data via a sidelink interface 3116. The UE 3104 is shown to be configured to access an access point (shown as AP 3118) via connection 3120. By way of example, the connection 3120 can comprise a local wireless connection, such as a connection consistent with any IEEE 802.11 protocol, wherein the AP 3118 may comprise a Wi-Fi® router. In this example, the AP 3118 may be connected to another network (for example, the Internet) without going through a CN 3124.

In embodiments, the UE 3102 and UE 3104 can be configured to communicate using orthogonal frequency division multiplexing (OFDM) communication signals with each other or with the base station 3112 and/or the base station 3114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 3112 or base station 3114 may be implemented as one or more software entities running on server computers as part of a virtual network. In addition, or in other embodiments, the base station 3112 or base station 3114 may be configured to communicate with one another via interface 3122. In embodiments where the wireless communication system 3100 is an LTE system (e.g., when the CN 3124 is an EPC), the interface 3122 may be an X2 interface. The X2 interface may be defined between two or more base stations (e.g., two or more eNBs and the like) that connect to an EPC, and/or between two eNBs connecting to the EPC. In embodiments where the wireless communication system 3100 is an NR system (e.g., when CN 3124 is a 5GC), the interface 3122 may be an Xn interface. The Xn interface is defined between two or more base stations (e.g., two or more gNBs and the like) that connect to 5GC, between a base station 3112 (e.g., a gNB) connecting to 5GC and an eNB, and/or between two eNBs connecting to 5GC (e.g., CN 3124).

The RAN 3106 is shown to be communicatively coupled to the CN 3124. The CN 3124 may comprise one or more network elements 3126, which are configured to offer various data and telecommunications services to customers/subscribers (e.g., users of UE 3102 and UE 3104) who are connected to the CN 3124 via the RAN 3106. The components of the CN 3124 may be implemented in one physical device or separate physical devices including components to read and execute instructions from a machine-readable or computer-readable medium (e.g., a non-transitory machine-readable storage medium).

In embodiments, the CN 3124 may be an EPC, and the RAN 3106 may be connected with the CN 3124 via an S1 interface 3128. In embodiments, the S1 interface 3128 may be split into two parts, an S1 user plane (S1-U) interface, which carries traffic data between the base station 3112 or base station 3114 and a serving gateway (S-GW), and the S1-MME interface, which is a signaling interface between the base station 3112 or base station 3114 and mobility management entities (MMEs).

In embodiments, the CN 3124 may be a 5GC, and the RAN 3106 may be connected with the CN 3124 via an NG interface 3128. In embodiments, the NG interface 3128 may be split into two parts, an NG user plane (NG-U) interface, which carries traffic data between the base station 3112 or base station 3114 and a user plane function (UPF), and the S1 control plane (NG-C) interface, which is a signaling interface between the base station 3112 or base station 3114 and access and mobility management functions (AMFs).

Generally, an application server 3130 may be an element offering applications that use internet protocol (IP) bearer resources with the CN 3124 (e.g., packet switched data services). The application server 3130 can also be configured to support one or more communication services (e.g., VoIP sessions, group communication sessions, etc.) for the UE 3102 and UE 3104 via the CN 3124. The application server 3130 may communicate with the CN 3124 through an IP communications interface 3132.

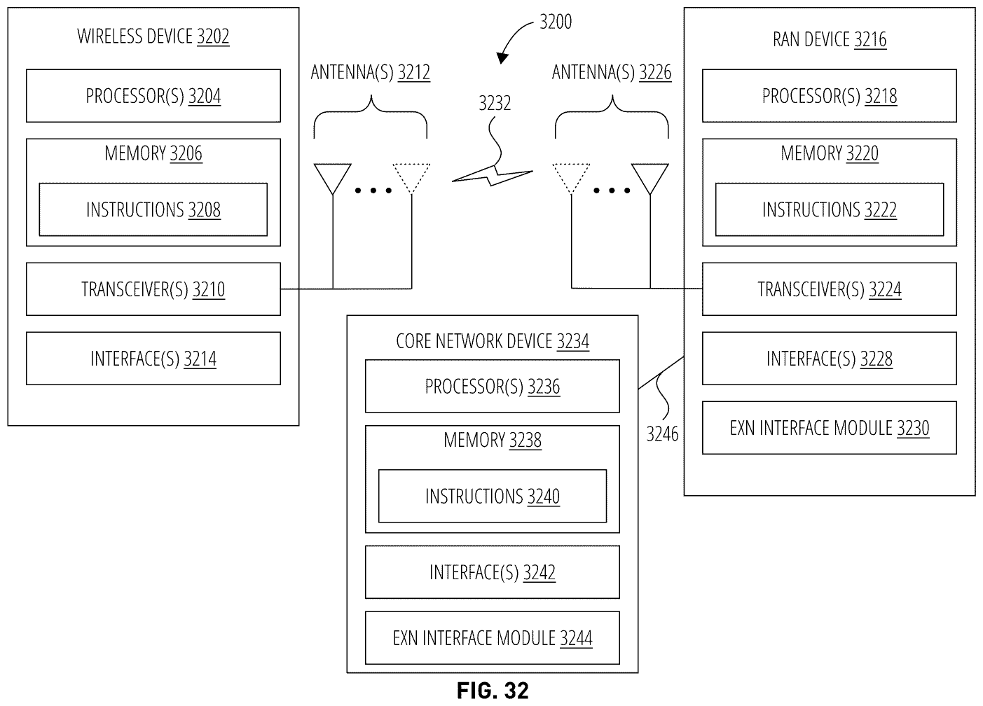

FIG. 32 illustrates a system 3200 for performing signaling 3232 between a wireless device 3202 and a RAN device 3216 connected to a CN device 3234, according to embodiments disclosed herein. The system 3200 may be a portion of a wireless communications system as herein described. The wireless device 3202 may be, for example, a UE of a wireless communication system. The RAN device 3216 may be, for example, a base station (e.g., an eNB or a gNB) of a wireless communication system. The CN device 3234 may be one or more devices making up a CN, as described herein.

The wireless device 3202 may include one or more processor(s) 3204. The processor(s) 3204 may execute instructions such that various operations of the wireless device 3202 are performed, as described herein. The processor(s) 3204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 3202 may include a memory 3206. The memory 3206 may be a non-transitory computer-readable storage medium that stores instructions 3208 (which may include, for example, the instructions being executed by the processor(s) 3204). The instructions 3208 may also be referred to as program code or a computer program. The memory 3206 may also store data used by, and results computed by, the processor(s) 3204.

The wireless device 3202 may include one or more transceiver(s) 3210 that may include radio frequency (RF) transmitter circuitry and/or receiver circuitry that use the antenna(s) 3212 of the wireless device 3202 to facilitate signaling (e.g., the signaling 3232) to and/or from the wireless device 3202 with other devices (e.g., the network CN device 3234) according to corresponding RATs.

The wireless device 3202 may include one or more antenna(s) 3212 (e.g., one, two, four, or more). For embodiments with multiple antenna(s) 3212, the wireless device 3202 may leverage the spatial diversity of such multiple antenna(s) 3212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 3202 may be accomplished according to precoding (or digital beamforming) that is applied at the wireless device 3202 that multiplexes the data streams across the antenna(s) 3212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 3202 may implement analog beamforming techniques, whereby phases of the signals sent by the antenna(s) 3212 are relatively adjusted such that the (joint) transmission of the antenna(s) 3212 can be directed (this is sometimes referred to as beam steering).

The wireless device 3202 may include one or more interface(s) 3214. The interface(s) 3214 may be used to provide input to or output from the wireless device 3202. For example, a wireless device 3202 that is a UE may include interface(s) 3214 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 3210/antenna(s) 3212 already described) that allow for communication between the UE and other devices and may operate according to known protocols (e.g., Wi-Fi®, Bluetooth®, and the like).

The RAN device 3216 may include one or more processor(s) 3218. The processor(s) 3218 may execute instructions such that various operations of the RAN device 3216 are performed, as described herein. The processor(s) 3218 may include one or more baseband processors implemented using, for example, a CPU, a DSP, an ASIC, a controller, an FPGA device, another hardware device, a firmware device, or any combination thereof configured to perform the operations described herein.

The RAN device 3216 may include a memory 3220. The memory 3220 may be a non-transitory computer-readable storage medium that stores instructions 3222 (which may include, for example, the instructions being executed by the processor(s) 3218). The instructions 3222 may also be referred to as program code or a computer program. The memory 3220 may also store data used by, and results computed by, the processor(s) 3218.

The RAN device 3216 may include one or more transceiver(s) 3224 that may include RF transmitter circuitry and/or receiver circuitry that use the antenna(s) 3226 of the RAN device 3216 to facilitate signaling (e.g., the signaling 3232) to and/or from the RAN device 3216 with other devices (e.g., the wireless device 3202) according to corresponding RATs.

The RAN device 3216 may include one or more antenna(s) 3226 (e.g., one, two, four, or more). In embodiments having multiple antenna(s) 3226, the RAN device 3216 may perform MIMO, digital beamforming, analog beamforming, beam steering, etc., as has been described.

The RAN device 3216 may include one or more interface(s) 3228. The interface(s) 3228 may be used to provide input to or output from the RAN device 3216. For example, a RAN device 3216 that is a base station may include interface(s) 3228 made up of transmitters, receivers, and other circuitry (e.g., other than the transceiver(s) 3224/antenna(s) 3226 already described) that enables the base station to communicate with other equipment in a core network, and/or that enables the base station to communicate with external networks, computers, databases, and the like for purposes of operations, administration, and maintenance of the base station or other equipment operably connected thereto.

The RAN device 3216 may include an eXn interface module 3230. The eXn interface module 3230 may be implemented via hardware, software, or combinations thereof. For example, the eXn interface module 3230 may be implemented as a processor, circuit, and/or instructions 3222 stored in the memory 3220 and executed by the processor(s) 3218. In some examples, the eXn interface module 3230 may be integrated within the processor(s) 3218 and/or the transceiver(s) 3224. For example, the cXn interface module 3230 may be implemented by a combination of software components (e.g., executed by a DSP or a general processor) and hardware components (e.g., logic gates and circuitry) within the processor(s) 3218 or the transceiver(s) 3224.

The eXn interface module 3230 may be used for various aspects of the present disclosure, for example, aspects of FIG. 28, FIG. 29, and/or FIG. 30.

In one embodiment, the eXn interface module 3230 configures the RAN device 3216 to receive, from a cloud entity, an instruction to transition a state of an eXn interface between the initiator air interface entity and a responder air interface entity from a starting state to an active state; transition, in response to the instruction, the eXn interface to the active state; and perform cross-air-interface-entity communication with the responder air interface entity over the eXn interface after the eXn interface is transitioned to the active state.

In another embodiment, the eXn interface module 3230 configures the RAN device 3216 to receive, from a cloud entity, an instruction to transition a state of an eXn interface between an initiator air interface entity and a responder air interface entity from a starting state to an inactive state; and transition, in response to the instruction, the eXn interface to the inactive state.

In one embodiment, the eXn interface module 3230 configures the RAN device 3216 to receive, from a cloud entity, an instruction to transition a state of an eXn interface between an initiator air interface entity and a responder air interface entity from an active state to a standby state; and transition, in response to the instruction, the eXn interface to the standby state.

The RAN device 3216 may communicate with the CN device 3234 via the interface 3246.

The CN device 3234 may include one or more processor(s) 3236. The processor(s) 3236 may execute instructions such that various operations of the CN device 3234 are performed, as described herein. The processor(s) 3236 may include one or more baseband processors implemented using, for example, a CPU, a DSP, an ASIC, a controller, an FPGA device, another hardware device, a firmware device, or any combination thereof configured to perform the operations described herein.

The CN device 3234 may include a memory 3238. The memory 3238 may be a non-transitory computer-readable storage medium that stores instructions 3240 (which may include, for example, the instructions being executed by the processor(s) 3236). The instructions 3240 may also be referred to as program code or a computer program. The memory 3238 may also store data used by, and results computed by, the processor(s) 3236.

The CN device 3234 may include one or more interface(s) 3242. The interface(s) 3242 may be used to provide input to or output from the CN device 3234. For example, a CN device 3234 may include interface(s) 3228 made up of transmitters, receivers, and other circuitry that enables the CN device 3234 to communicate with other equipment in the CN, and/or that enables the CN device 3234 to communicate with external networks, computers, databases, and the like for purposes of operations, administration, and maintenance of the CN device 3234 or other equipment operably connected thereto.

The CN device 3234 may include an eXn interface module 3244. The eXn interface module 3244 may be implemented via hardware, software, or combinations thereof. For example, the eXn interface module 3244 may be implemented as a processor, circuit, and/or instructions 3240 stored in the memory 3238 and executed by the processor(s) 3236. In some examples, the eXn interface module 3244 may be integrated within the processor(s) 3236. For example, the eXn interface module 3244 may be implemented by a combination of software components (e.g., executed by a DSP or a general processor) and hardware components (e.g., logic gates and circuitry) within the processor(s) 3236.

The eXn interface module 3244 may be used for various aspects of the present disclosure, for example, aspects of CN-based procedures discussed herein.

Embodiments contemplated herein include an apparatus comprising means to perform one or more elements of any one or more of the method 2800, the method 2900, and/or the method 3000. This apparatus may be, for example, an apparatus of a base station or part of a base station (such as a RAN device 3216 that is a base station or part of a base station, as described herein).

Embodiments contemplated herein include one or more non-transitory computer-readable media comprising instructions to cause an electronic device, upon execution of the instructions by one or more processors of the electronic device, to perform one or more elements of any one or more of the method 2800, the method 2900, and/or the method 3000. This non-transitory computer-readable media may be, for example, a memory of a base station or part of a base station (such as a memory 3220 of a RAN device 3216 that is a base station or part of a base station, as described herein).

Embodiments contemplated herein include an apparatus comprising logic, modules, or circuitry to perform one or more elements of any one or more of the method 2800, the method 2900, and/or the method 3000. This apparatus may be, for example, an apparatus of a base station or part of a base station (such as a RAN device 3216 that is a base station or part of a base station, as described herein).

Embodiments contemplated herein include an apparatus comprising: one or more processors and one or more computer-readable media comprising instructions that, when executed by the one or more processors, cause the one or more processors to perform one or more elements of any one or more of the method 2800, the method 2900, and/or the method 3000. This apparatus may be, for example, an apparatus of a base station or part of a base station (such as a RAN device 3216 that is a base station or part of a base station, as described herein).

Embodiments contemplated herein include a signal as described in or related to one or more elements of any one or more of the method 2800, the method 2900, and/or the method 3000.

Embodiments contemplated herein include a computer program or computer program product comprising instructions, wherein execution of the program by a processing element is to cause the processing element to carry out one or more elements of any one or more of the method 2800, the method 2900, and/or the method 3000. The processor may be a processor of a base station or part of a base station (such as a processor(s) 3218 of a RAN device 3216 that is a base station or part of a base station, as described herein). These instructions may be, for example, located in the processor and/or on a memory of the base station or part of a base station (such as a memory 3220 of a RAN device 3216 that is a base station or part of a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of an initiator air interface entity of a cell-free network using dynamic associations of air interface entities and cloud entities, comprising:
receiving, from a cloud entity, an instruction to transition a state of an eXn interface between the initiator air interface entity and a responder air interface entity from a starting state to an active state;
transitioning, in response to the instruction, the eXn interface to the active state; and
performing cross-air-interface-entity communication with the responder air interface entity over the eXn interface after the eXn interface is transitioned to the active state.

2. The method of claim 1, wherein the starting state comprises an inactive state.

3. The method of claim 2, wherein the transitioning comprises:
broadcasting a discovery signal; and
receiving, from the responder air interface entity, in response to the discovery signal, a discovery signal response that identifies the responder air interface entity to the initiator air interface entity.

4. The method of claim 2, wherein the transitioning comprises:
sending, to the responder air interface entity, a parameter proposal for a parameter that defines the eXn interface; and
receiving, from the responder air interface entity, in response to the parameter proposal, an approval of the parameter proposal.

5. The method of claim 2, wherein the transitioning comprises performing a security key exchange with the responder air interface entity.

6. The method of claim 1, wherein the starting state comprises a standby state.

7. The method of claim 6, wherein the transitioning comprises:
broadcasting a reactivation signal comprising a stored eXn configuration; and
receiving, from the responder air interface entity, in response to the reactivation signal, a reactivation signal acknowledgement that indicates that the responder air interface entity is ready to use the stored eXn configuration for the eXn interface.

8. The method of claim 6, wherein the transitioning comprises:
determining, based on a current network condition, an updated parameter for a stored eXn configuration;
sending, to the responder air interface entity, the updated parameter for the stored eXn configuration; and
receiving, from the responder air interface entity, in response to the updated parameter, a parameter update acknowledgment indicating that the responder air interface entity is ready to use the updated parameter for the eXn interface.

9. The method of claim 6, wherein the transitioning comprises:
sending, to the responder air interface entity, security context information for a previous security context between the initiator air interface entity and the responder air interface entity; and
receiving, from the responder air interface entity, in response to the security context information for the previous security context, an indication that the responder air entity is ready to use the previous security context.

10. A method of an initiator air interface entity of a cell-free network using dynamic associations of air interface entities and cloud entities, comprising:
receiving, from a cloud entity, an instruction to transition a state of an eXn interface between an initiator air interface entity and a responder air interface entity from a starting state to an inactive state; and
transitioning, in response to the instruction, the eXn interface to the inactive state.

11. The method of claim 10, wherein the starting state comprises an active state.

12. The method of claim 10, wherein the starting state comprises a standby state.

13. The method of claim 10, wherein the transitioning comprises:
sending, to the responder air interface entity, a session handling message indicating a destination interface for a current session on the eXn interface; and
receiving, from the responder air interface entity, a destination interface acknowledgment indicating that the current session has been transferred to the destination interface.

14. The method of claim 10, wherein the transitioning comprises:
sending, to the responder air interface entity, data handling instructions indicating an intended destination of pending data of a current session on the eXn interface; and
receiving, from the responder air interface entity, in response to the data handling instructions, a data handling acknowledgement indicating that the pending data has been flushed to the intended destination.

15. The method of claim 10, wherein the transitioning comprises:
sending, to the responder air interface entity, a de-authentication request instructing the responder air interface entity to release a security context between the initiator air interface entity and the responder air interface entity; and
receiving, from the responder air interface entity, in response to the de-authentication request, a de-authentication acknowledgement indicating that the responder air interface entity has released the security context.

16. A method of an initiator air interface entity of a cell-free network using dynamic associations of air interface entities and cloud entities, comprising:
receiving, from a cloud entity, an instruction to transition a state of an eXn interface between an initiator air interface entity and a responder air interface entity from an active state to a standby state; and
transitioning, in response to the instruction, the eXn interface to the standby state.

17. The method of claim 16, wherein the transitioning comprises:
sending, to the responder air interface entity, a session handing message comprising instructions for maintaining a session state for a current session on the eXn interface; and
receiving, from the responder air interface entity, a session handing acknowledgement indicating that the current session will be maintained on the eXn interface.

18. The method of claim 16, wherein the transitioning comprises:
sending, to the responder air interface entity, a partial de-authentication request instructing the responder air interface entity to partially release a security context between the initiator air interface entity and the responder air interface entity; and
receiving, from the responder air interface entity, in response to the de-authentication request, a partial de-authentication acknowledgement indicating that the responder air interface entity has partially released the security context.
